(19) United States
(12) Patent Application Publication
(10) Pub. No.: US 2023/0032822 A1
(43) Pub. Date: Feb. 2, 2023

(54) SYSTEMS AND METHODS FOR ADAPTING MACHINE LEARNING MODELS

(71) Applicant: ElectrifAi, LLC, Allamuchy, NJ (US)

(72) Inventors: Luming Wang, Bellevue, WA (US); Huiping Li, Clarksville, MD (US); Geoffrey Xiao, Lexington, MA (US); Jinhua Ma, Jersey City, NJ (US)

(73) Assignee: ElectrifAi, LLC, Allamuchy, NJ (US)

(21) Appl. No.: 17/876,026

(22) Filed: Jul. 28, 2022

Related U.S. Application Data
(60) Provisional application No. 63/227,987, filed on Jul. 30, 2021.

(51) Int. Cl. G06N 20/20

(52) U.S. Cl. CPC G06N 20/20

(57) ABSTRACT

A method comprising: obtaining information about training data comprising first inputs and first outputs, comprising a first representation of a first distribution of the first inputs and first performance data indicative of a measure of performance of a trained machine learning (ML) model on the first inputs; obtaining information about new data comprising second inputs and second outputs, comprising a second representation of a second distribution of the second inputs and second performance data indicative of the measure of performance of the trained ML model on the second inputs; determining, using the first representation, the second representation, the first performance data, and the second performance data, whether to update the trained ML model or to generate a supplemental ML model; and when it is determined to update the trained ML model or to generate the supplemental ML model, updating the trained ML model or generating the supplemental ML model.

### CROSS-REFERENCE TO RELATED APPLICATIONS

This application claims the benefit of priority, under 35 U.S.C. § 119, to U.S. Provisional Patent Application Ser. No. 63/227,987, filed on Jul. 30, 2021, titled “Systems and Methods for Adapting Machine Learning Models”, which is incorporated by reference herein in its entirety.

### BACKGROUND

Machine learning models are widely applied to multiple different types of problems in multiple different applications. A machine learning model contains multiple parameters. Prior to being applied to a particular problem, a machine learning model is trained by using training data to estimate values of its parameters. The resulting trained machine learning model may be applied to input data to produce corresponding outputs.

### SUMMARY

Some embodiments provide for a method, comprising: using at least one computer hardware processor to perform: (A) obtaining information about training data used to generate a trained machine learning (ML) model, the training data comprising a first plurality of inputs and a corresponding first plurality of outputs, the information about the training data comprising: a first representation of a first distribution of the first plurality of inputs, and first performance data indicative of a measure of performance of the trained ML model on the first plurality of inputs; (B) obtaining information about new data to which the trained ML model was applied, the new data comprising a second plurality of inputs and a corresponding second plurality of outputs, the information about the new data comprising: a second representation of a second distribution of the second plurality of inputs, and second performance data indicative of the measure of performance of the trained ML model on the second plurality of inputs; (C) determining, using the first representation, the second representation, the first performance data, and the second performance data, whether to update the trained ML model or to generate a supplemental ML model to use with the trained ML model; and (D) when it is determined to update the trained ML model or to generate the supplemental ML model to use with the trained ML model, updating the trained ML model to generate an updated ML model or generating the supplemental ML model to use with the trained ML model.

Some embodiments provide for a system, comprising: at least one computer hardware processor; and at least one non-transitory computer-readable storage medium storing processor-executable instructions that, when executed by the at least one computer hardware processor, cause the at least one computer hardware processor to perform: (A) obtaining information about training data used to generate a trained machine learning (ML) model, the training data comprising a first plurality of inputs and a corresponding first plurality of outputs, the information about the training data comprising: a first representation of a first distribution of the first plurality of inputs, and first performance data indicative of a measure of performance of the trained ML model on the first plurality of inputs; (B) obtaining information about new data to which the trained ML model was applied, the new data comprising a second plurality of inputs and a corresponding second plurality of outputs, the information about the new data comprising: a second representation of a second distribution of the second plurality of inputs, and second performance data indicative of the measure of performance of the trained ML model on the second plurality of inputs; (C) determining, using the first representation, the second representation, the first performance data, and the second performance data, whether to update the trained ML model or to generate a supplemental ML model to use with the trained ML model; and (D) when it is determined to update the trained ML model or to generate the supplemental ML model to use with the trained ML model, updating the trained ML model to generate an updated ML model or generating the supplemental ML model to use with the trained ML model.

Some embodiments provide for at least one non-transitory computer-readable storage medium storing processor-executable instructions that, when executed by at least one computer hardware processor, cause the at least one computer hardware processor to perform: (A) obtaining information about training data used to generate a trained machine learning (ML) model, the training data comprising a first plurality of inputs and a corresponding first plurality of outputs, the information about the training data comprising: a first representation of a first distribution of the first plurality of inputs, and first performance data indicative of a measure of performance of the trained ML model on the first plurality of inputs; (B) obtaining information about new data to which the trained ML model was applied, the new data comprising a second plurality of inputs and a corresponding second plurality of outputs, the information about the new data comprising: a second representation of a second distribution of the second plurality of inputs, and second performance data indicative of the measure of performance of the trained ML model on the second plurality of inputs; (C) determining, using the first representation, the second representation, the first performance data, and the second performance data, whether to update the trained ML model or to generate a supplemental ML model to use with the trained ML model; and (D) when it is determined to update the trained ML model or to generate the supplemental ML model to use with the trained ML model, updating the trained ML model to generate an updated ML model or generating the supplemental ML model to use with the trained ML model.

In some embodiments, act (C) comprises determining to update the trained ML model and act (D) comprises updating the trained ML model to generate the updated ML model.

In some embodiments, updating the trained ML model comprises: training, using at least some of the new data, a second trained ML model; generating the updated ML model as an ensemble of the trained ML model and the second trained ML model.

In some embodiments, generating the updated ML model further comprises determining weights for the trained ML model and the second trained ML model in the ensemble.

In some embodiments, determining the weights is performed by using gradient descent.

In some embodiments, the method further comprises: obtaining information about second training data used to generate the updated machine learning model, the second training data comprising a third plurality of inputs and a corresponding third plurality of outputs, the information about the second training data comprising: a third representation of a third distribution of the third plurality of inputs, and third performance data indicative of a measure of performance of the updated ML model on the third plurality of inputs; obtaining information about second new data to which the updated ML model was applied, the second new data comprising a fourth plurality of inputs and a corresponding fourth plurality of outputs, the information about the second new data comprising: a fourth representation of a fourth distribution of the fourth plurality of inputs, and fourth performance data indicative of the measure of performance of the updated ML model on the fourth plurality of inputs; determining, using the third representation, the fourth representation, the third performance data, and the fourth performance data, whether to further update the updated ML model or to generate a further supplemental ML model to use with the updated ML model; and when it is determined to further update the updated ML model or to generate the further supplemental ML model to use with the updated ML model, updating the updated ML model or generating the further supplemental ML model.

In some embodiments, the second training data comprises the training data and the new data.

In some embodiments, act (C) comprises determining to generate the supplemental ML model to use with the trained ML model and act (D) comprises generating the supplemental ML model.

In some embodiments, generating the supplemental ML model comprises: training, using at least some of the new data, the supplemental ML model; associating the trained ML model with a first portion of an input data domain; and associating the supplemental ML model with a second portion of the input data domain.

In some embodiments, the method further comprises: obtaining new input data; determining whether the new input data is in the first portion of the input data domain or in the second portion of the input data domain; when it is determined that the new input data is in the first portion of the input data domain, providing the new input data as input to the trained ML model to obtain a first corresponding output; and when it is determined that the new input data is in the second portion of the input data domain, providing the new input data as input to the supplemental ML model to obtain a second corresponding output.

In some embodiments, the method further comprises: monitoring performance of the trained ML model and the supplemental ML model; and adjusting portions of the input data domain associated with the trained ML model and the supplemental ML model based on results of the monitoring.

In some embodiments, adjusting the portions comprises adjusting a boundary between the first portion of the input data domain and the second portion of the input data domain thereby changing the first portion and the second portion of the input data domain.

In some embodiments, the method further comprises: obtaining information about second training data used to generate the supplemental ML model, the second training data comprising a third plurality of inputs and a corresponding third plurality of outputs, the information about the second training data comprising: a third representation of a third distribution of the third plurality of inputs, and third performance data indicative of a measure of performance of the supplemental ML model on the third plurality of inputs; obtaining information about second new data to which the supplemental ML model was applied, the second new data comprising a fourth plurality of inputs and a corresponding fourth plurality of outputs, the information about the second new data comprising: a fourth representation of a fourth distribution of the fourth plurality of inputs, and fourth performance data indicative of the measure of performance of the supplemental ML model on the fourth plurality of inputs; determining, using the third representation, the fourth representation, the third performance data, and the fourth performance data, whether to further update the supplemental ML model or to generate a second supplemental ML model to use with the trained ML model and the supplemental ML model; and when it is determined to further update the supplemental ML model or to generate the second supplemental ML model to use with the trained ML model and the supplemental ML model, updating the supplemental ML model or generating the second supplemental ML model.

In some embodiments, the first representation of the first distribution of the first plurality of inputs comprises a histogram having a plurality of bins and a plurality of counts corresponding to the plurality of bins, each of the plurality of counts indicating how many of the first plurality of inputs fall into a respective bin in the plurality of bins.

In some embodiments, the first performance data indicative of the measure of performance of the trained ML model on the first plurality of inputs comprises: for each bin of at least some of the plurality of bins, a measure of average error by the trained ML model when applied to inputs, among the first plurality of inputs, that fall in the bin.

In some embodiments, the method further comprises: prior to obtaining the information about the new data, applying the trained ML model to the second plurality of inputs to obtain the second plurality of outputs.

In some embodiments, the method further comprises: prior to obtaining the information about the training data, training, using the first plurality of inputs and the first plurality of outputs, an untrained ML model to generated the trained ML model.

In some embodiments, the determining is performed based on a comparison between the first representation and the second representation.

In some embodiments, comparing the first representation and second representation comprises determining a Kullback-Liebler (KL) divergence between the first representation and the second representation.

In some embodiments, the determining is performed further based on a comparison between the first performance data and the second performance data.

In some embodiments, the determining comprises: determining a first value based on the comparison between the first representation and the second representation; determining a second value based on the comparison between the first performance data and the second performance data; and determining, based on a weighted combination of the first value and the second value, whether to update the trained ML model or to generate a supplemental ML model to use with the trained ML model.

In some embodiments, the first representation comprises a first histogram having a first plurality of counts for a plurality of bins, and the second representation comprises a second histogram having a second plurality of counts for the plurality of bins, the first performance data comprises, for each bin of at least some of the plurality of bins, a measure of error incurred by the trained ML model when applied to inputs, among the first plurality of inputs, that fall in the bin, and the second performance data comprises, for each bin of at least some of the plurality of bins, a measure of error incurred by the trained ML model when applied to inputs, among the second plurality of inputs, that fall in the bin.

In some embodiments, determining whether to update the trained ML model or to generate a supplemental ML model comprises: determining a number of bins, among the plurality of bins, for which a difference between measures of error specified by the first performance data and the second performance data exceeds an average difference between the measures of error across the plurality of bins; determining to update the trained ML model when the number of bins exceeds a pre-determined threshold number of bins; and determining to generate a supplemental ML model when the number of bins is less or equal to the pre-determined threshold number of bins.

In some embodiments, the trained ML model comprises a linear regression model or a non-linear regression model.

In some embodiments, the trained ML model comprises a ML model configured to map inputs to outputs in a finite set of outputs corresponding to classification labels or actions.

In some embodiments, the method further comprises: prior to obtaining the information about the new data, identifying at least some of the second plurality of inputs for which corresponding ground truth values are to be obtained.

In some embodiments, the identifying is performed based on the first representation of the first distribution of the first plurality of inputs.

In some embodiments, the first representation of the first distribution of the first plurality of inputs comprises a first histogram having a plurality of bins, the second representation of the second distribution of the second plurality of inputs comprises a second histogram having the plurality of bins, the method further comprises: identifying, using the first representation, the second representation, the first performance data and the second performance data, one or more bins for which to obtain additional inputs and corresponding ground truth values for improving performance of the trained ML model.

It should be appreciated that all combinations of the foregoing concepts and additional concepts described in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

Various non-limiting embodiments of the technology will be described with reference to the following figures. It should be appreciated that the figures are not necessarily drawn to scale.

FIG. 1 is a block diagram illustrating techniques for adapting a machine learning (ML) model, in accordance with some embodiments of the technology described herein;

FIG. 2 is a flowchart of an illustrative process for adapting an ML model, in accordance with some embodiments of the technology described herein;

FIGS. 3A-3B show illustrative examples where it is determined whether to adapt an ML model, in accordance with some embodiments of the technology described herein;

FIG. 4A is a block diagram illustrating an ML model and an updated ML model (as an ensemble of the ML model and a boost ML model), in accordance with some embodiments of the technology described herein;

FIG. 4B is a flowchart of an illustrative process for adapting an ML model as shown in FIG. 4A, in accordance with some embodiments of the technology described herein;

FIG. 5A is a block diagram illustrating an ML model and a supplemental ML model to use with the ML model, in accordance with some embodiments of the technology described herein;

FIG. 5B is a flowchart of an illustrative process for adapting an ML model as shown in FIG. 5A, in accordance with some embodiments of the technology described herein;

FIG. 5C is a flowchart of an illustrative process for determining whether to provide new input data to an ML model or a supplemental ML model, in accordance with some embodiments of the technology described herein;

FIG. 6A is a block diagram illustrating an ML model, an updated ML model (as a first ensemble of the ML model and a boost ML model), and another updated ML model (as a second ensemble of the ML model, the boost ML model, and a second boost ML model), in accordance with some embodiments of the technology described herein;

FIG. 6B is a block diagram illustrating an ML model, an updated ML model (as an ensemble of the ML model and a boost ML model), and a supplemental ML model to use with the updated ML model, in accordance with some embodiments of the technology described herein;

FIG. 6C is a flowchart of an illustrative process for adapting an ML model as shown in FIG. 6A or as shown in FIG. 6B, in accordance with some embodiments of the technology described herein;

FIG. 7A is a block diagram illustrating an ML model, a supplemental ML model to use with the ML model, and an updated supplemental ML model (as an ensemble of the supplemental ML model and a boost ML model), in accordance with some embodiments of the technology described herein;

FIG. 7B is a block diagram illustrating an ML model, a supplemental ML model, and a second supplemental ML model to use with the ML model and the supplemental ML model, in accordance with some embodiments of the technology described herein;

FIG. 7C is a flowchart of an illustrative process for adapting an ML model as shown in FIG. 7A or as shown in FIG. 7B, in accordance with some embodiments of the technology described herein; and

FIG. 8 schematically illustrates components of a computer that may be used to implement some embodiments of the technology described herein.

### DETAILED DESCRIPTION

Aspects of the technology described herein relate to improvements in machine learning (ML) technology. In particular, the inventors have developed new techniques for adapting trained ML models to account for new observed data being different from the data used to train a trained ML model in the first place.

Enterprises, businesses, and individuals apply ML models to collected data and use the resulting outputs (e.g., predictions, classifications, recommended actions, etc.) in a wide variety of applications. ML models perform relatively well when applied to examples that are similar to the data on which they were trained. However, ML models do not perform well when applied to data that is dissimilar from the data on which they were trained. The conventional approach to address the problem of mismatch between the data on which an ML model was trained and new data to which the ML model is applied involves a time-consuming process of replacing the existing ML model with an entirely new ML model.

The inventors have recognized that conventional techniques for updating an ML model suffer from two problems. First, the conventional techniques do not take into account what part of the input data domain the new data comes from. For example, the original training data may have examples from a portion of the input data domain different from the portion of the input data domain from which the new data comes. The original ML model may perform poorly on the new data as the original ML model was not trained on any data from that portion of the input data domain to which the new data belongs. Second, the conventional techniques are wholly manual and require creating an entirely new ML model to replace the original ML model. Not only is this approach time consuming and expensive, it is also error prone as an entirely new ML model is created to replace the existing ML model.

The inventors have developed techniques to adapt an ML model that identify whether the new data is from a portion of the input data domain different from the portion of the input data domain for training data on which the ML model was originally trained. To account for this disparity in the source of the new data and the training data, the developed techniques adapt the ML model in different ways and do so automatically. For example, the developed techniques may involve updating the trained ML model by training a second trained ML model and generating an updated ML model as an ensemble of the originally trained ML model and the second trained ML model. In another example, the developed techniques may involve generating a supplemental ML model to use with the trained ML model (e.g., either the trained ML model or the supplemental ML model may be used depending on where provided input falls in the input data domain). In this way, the techniques developed by the inventors improve ML technology by enabling automatic adapting, without manual intervention, of ML models in different ways depending on the source of the new data. Additionally, the developed techniques save time and cost compared to conventional techniques where data analysts manually review and process new data and create an entirely new ML model using the manually processed data.

There are various aspects of the techniques developed by the inventors that enable the improvements to ML technology described above. In some aspects, a method includes obtaining information about training data used to generate a trained ML model (e.g., a linear regression model, a non-linear regression model such as neural networks, support vector machines, etc., or any other suitable ML model). The training data includes first inputs and corresponding first outputs. The information about the training data includes a first representation (e.g., a first histogram, a first kernel density estimate, or any other suitable representation) of a first distribution of the first inputs and first performance data indicative of a measure of performance (e.g., a measure of average error, a measure of mean squared error, or any other suitable measure of performance) of the trained ML model on the first inputs.

The method further includes obtaining information about new data to which the trained ML model was applied. The new data includes second inputs and corresponding second outputs. The information about the new data includes a second representation (e.g., a second histogram, a second kernel density estimate, or any other suitable representation) of a second distribution of the second inputs and second performance data indicative of the measure of performance (e.g., a measure of average error, a measure of mean squared error, or any other suitable measure of performance) of the trained ML model on the second inputs.

The method further includes determining, using the first representation, the second representation, the first performance data, and the second performance data, whether to update the trained ML model or to generate a supplemental ML model to use with the trained ML model. When it is determined to update the trained ML model or to generate the supplemental ML model to use with the trained ML model, the method further includes updating the trained ML model to generate an updated ML model or generating the supplemental ML model to use with the trained ML model.

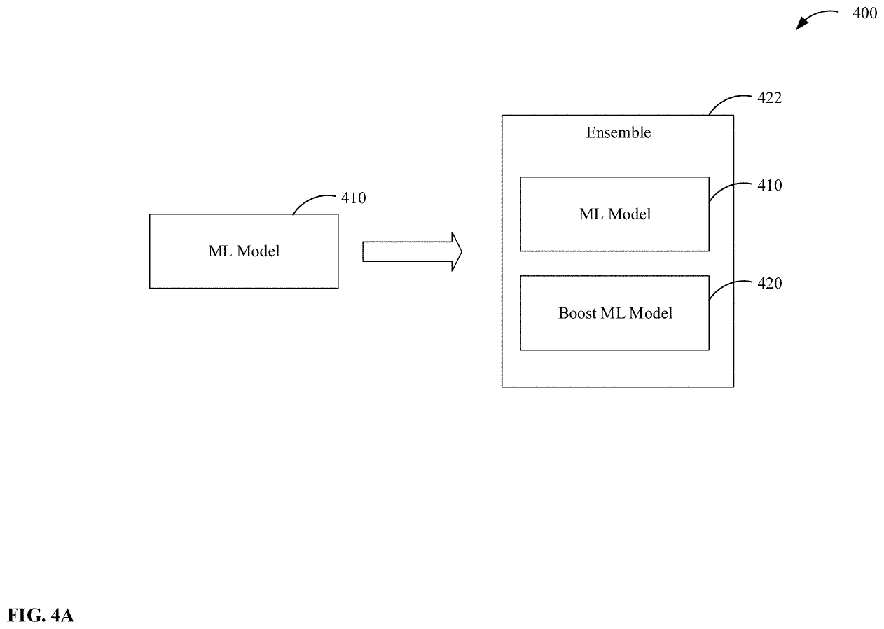

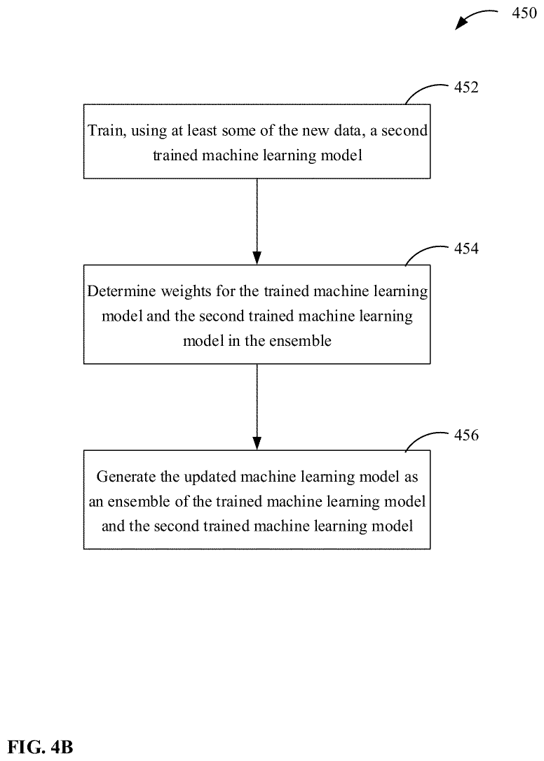

In some embodiments, updating the trained ML model may include training a second trained ML model (e.g., a boost ML model, or any other suitable ML model; described with respect to FIG. 4A) and generating an updated ML model as an ensemble of the trained ML model and the second trained ML model. In some embodiments, the second trained ML model may be a boost ML model generated using AdaBoost, XGBoost, Gradient Boosting Machine (GBM), or any other suitable boosting algorithm. In some embodiments, a boosting algorithm includes training one or more additional ML models on some or all of the training data and/or some or all of the new data and adding the additional ML model to an ensemble including the trained ML model which was trained on the training data. When the additional ML model is added to the ensemble, the trained ML model and the additional ML model are weighted (e.g., using a gradient descent algorithm, or any other suitable algorithm) in a way that improves overall accuracy for the ensemble. When training an additional ML model, input on which the trained ML model has low accuracy (e.g., the predicted outputs have average error higher than a threshold) is assigned a higher weight and input on which the trained ML model has high accuracy (e.g., the predicted outputs have average error lower than the threshold) is assigned a lower weight. Thus, the additional ML model may focus more on input on which the trained ML model performed poorly.

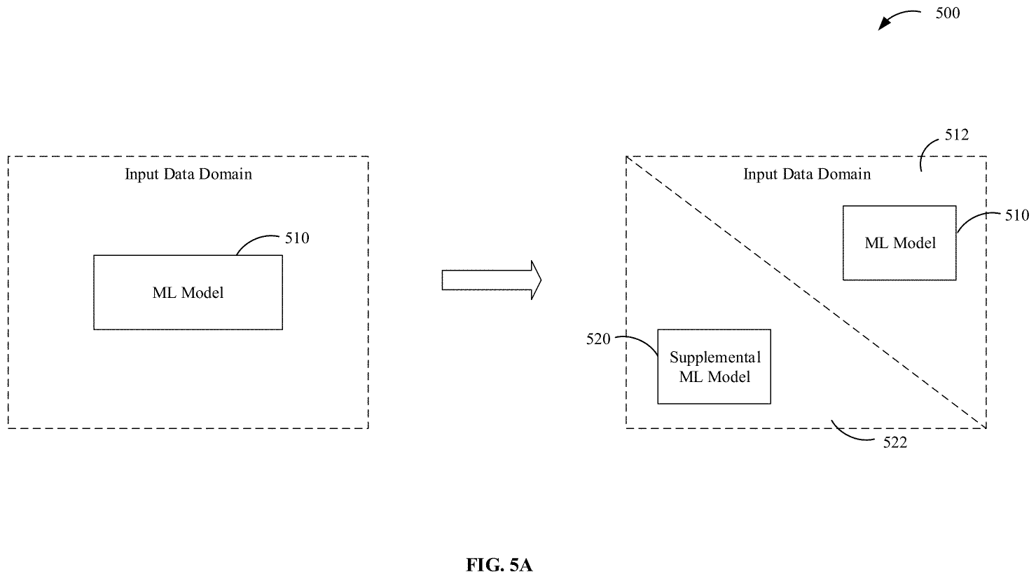

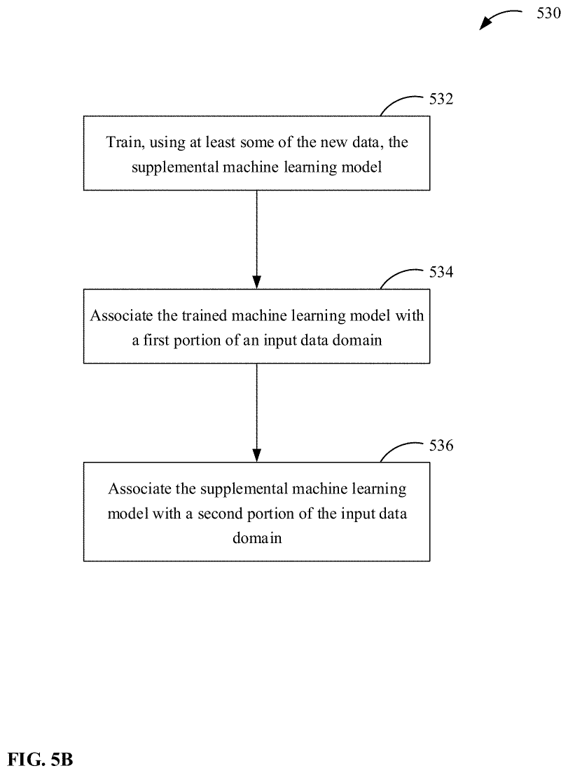

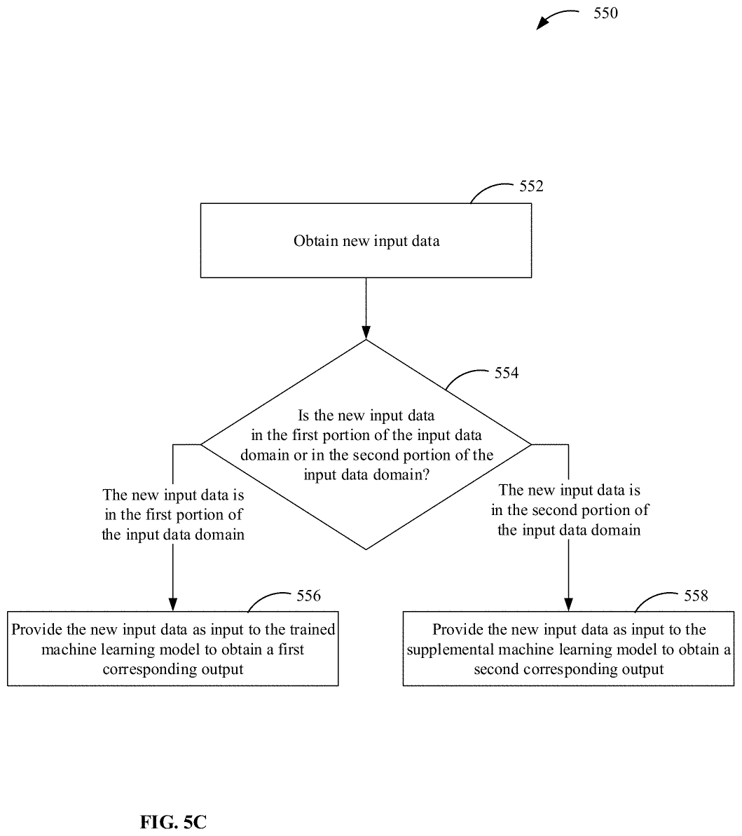

In some embodiments, generating the supplemental ML model to use with the trained ML model may include training the supplemental ML model, associating the trained ML model with a first portion of an input data domain, and associating the supplemental ML model with a second portion of the input data domain different from the first portion of the input data domain. In some embodiments, the supplemental ML model may be a supplemental ML model as described with respect to FIG. 5A, or any other suitable supplemental ML model.

Conventional techniques for deploying ML models have included deploying a trained ML model in a containerized application program, such as a DOCKER container application. However, such conventional deployments have included only the trained ML model in the containerized application program. As a result, any steps to assess performance of the ML model or to adapt the ML model are conventionally performed offline, outside of the containerized application program. After performing their offline analysis, the data analyst would re-deploy the ML model in a new containerized application program.

In contrast, the inventors have developed an improved approach where the ML model is deployed in a containerized application program (or any other suitable virtualized application program) that includes not only a trained ML model but also additional software that allows for the deployed ML model to not only be used for inference, but also for monitoring performance of the ML model and for training (e.g., re-training from scratch using new data or updating at least some of the already trained parameters using new data). The inclusion of these additional software in the same containerized application as the ML model itself, allow for all such tasks to be within the containerized application program, without any need for performing offline analysis or re-deploying the ML model in a new containerized application program.

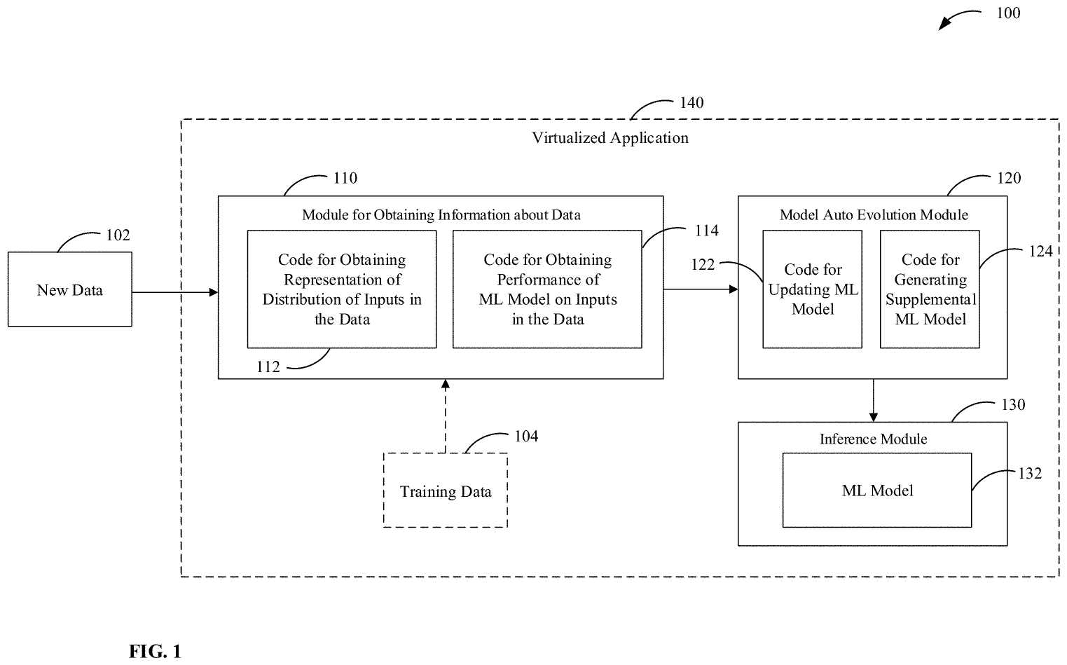

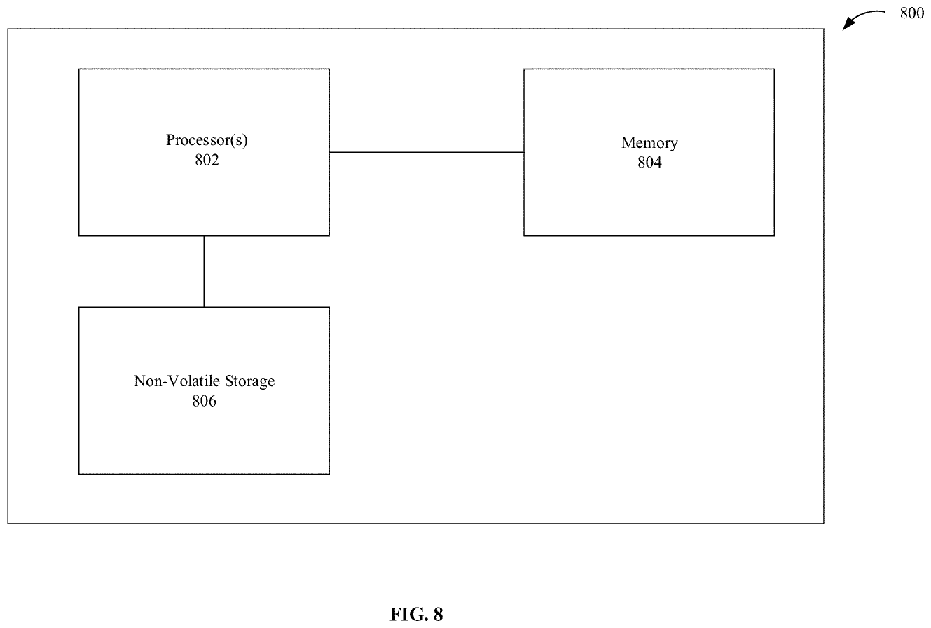

Accordingly, in some embodiments, at least some of the techniques described herein are performed by a virtualized ML application program executing using at least one computer hardware processor (e.g., processor 802 in FIG. 8, or any other suitable processor). In some embodiments, a virtualized application program may be any application program configured to execute on a virtual machine (e.g., a VMWARE virtual machine, an AZURE virtual machine, etc.). In some embodiments, a virtualized application program may be a containerized application program configured to execute in a container such as a DOCKER container, a MOBY container, etc. An exemplary embodiment of such a virtualized ML application program is described with respect to FIG. 1.

In some embodiments, the virtualized ML application program (or any other suitable program for performing at least some of the techniques described herein) may receive new data. The new data may provide ground truth outputs for previous inputs on which the trained ML model was applied to generate ML outputs. Additionally or alternatively, the new data may include additional training data from recent customers to which the trained ML model has not yet been applied. The new data may be used to monitor performance of the trained ML model. In some embodiments, based on monitoring the performance, the virtualized ML application program may trigger adapting the trained ML model if the model performance is not below a specified error threshold. For example, if the model's performance for the ML output is not below the specified error threshold, the virtualized ML application program may trigger adapting the trained ML model using at least some of prior training data and/or at least some of the new data. In some embodiments, the virtualized ML application program may trigger adapting the trained ML model on a periodic interval (e.g., every week, every month, every two months, or any other suitable interval). In some embodiments, the virtualized ML application program may trigger adapting the trained ML model when a threshold amount (e.g., 20% of the size of the training data initially used to generate the trained ML model, 50% of the size of the training data initially used to generate the trained ML model, or any other suitable threshold) of new data is available. The virtualized ML application program may implement some or all of the described techniques and/or any other suitable techniques for determining whether to adapt the trained ML model. Thus, it should be appreciated that any such variations are within the scope of the techniques described herein and aspects of the technology described herein are not limited in this respect.

In some embodiments, it is determined to not adapt the trained ML model (e.g., it is determined neither to update the trained ML model nor to generate a supplemental ML model). In some embodiments, the act of determining whether to update the trained ML model or to generate a supplemental ML model includes determining neither to update the trained ML model nor to generate the supplemental ML model. For example, it may be determined to not adapt the trained ML model because no new data, with ground truth outputs for previous inputs on which the trained ML model was applied to generate ML outputs, may be received. In another example, it may be determined to not adapt the trained ML model because new data may be received but may be less than a threshold amount of new data required to trigger adapting the trained ML model. In yet another example, it may be determined to not adapt the trained ML model because the model performance is below a specified error threshold. In yet another example, it may be determined to not adapt the trained ML model because the current time does not comply with a periodic interval for adapting the trained ML model.

In some embodiments, it is determined to adapt the trained ML model. For example, it may be determined to adapt the trained ML model because new data may be received, including additional training data from recent customers to which the trained ML model has not yet been applied. In another example, it may be determined to adapt the trained ML model because the received new data may be more than a threshold amount of new data required to trigger adapting the trained ML model. In yet another example, it may be determined to adapt the trained ML model because the model performance is not below a specified error threshold. In yet another example, it may be determined to adapt the trained ML model because the current time complies with a periodic interval for adapting the trained ML model.

In some embodiments, it is determined to update the training ML model. In such embodiments, the act of determining whether to update the trained ML model or to generate a supplemental ML model includes determining to update the trained ML model. Further, the act of updating the trained ML model or generating the supplemental ML model, when it is determined to update the trained ML model or to generate the supplemental ML model, includes updating the trained ML model to generate the updated ML model. For example, updating the trained ML model may include training a second trained ML model (e.g., a boost ML model, or any other suitable ML model; described with respect to FIG. 4A) and generating an updated ML model as an ensemble of the trained ML model and the second trained ML model.

In some embodiments, the act of updating the trained ML model includes training, using at least some of the new data, a second trained ML model (e.g., a boost ML model, or any other suitable ML model) and generating the updated ML model as an ensemble of the trained ML model and the second trained ML model. In some embodiments, the second trained ML model may be a boost ML model generated using AdaBoost, XGBoost, Gradient Boosting Machine (GBM), or any other suitable boosting algorithm. In some embodiments, a boosting algorithm includes training the second trained ML model on some or all of the training data and/or some or all of the new data and adding the second trained ML model to an ensemble including the trained ML model which was trained on the training data.

In some embodiments, generating the updated ML model further includes determining weights for the trained ML model and the second trained ML model in the ensemble. For example, when the second trained ML model is added to the ensemble, the trained ML model and the second trained ML model are weighted in a way that improves overall accuracy for the ensemble. In some embodiments, when training the second trained ML model, input on which the trained ML model has low accuracy (e.g., the predicted outputs have average error higher than a threshold) is assigned a higher weight and input on which the trained ML model has high accuracy (e.g., the predicted outputs have average error lower than the threshold) is assigned a lower weight. Thus, the second trained ML model may focus more on input on which the trained ML model performed poorly. In some embodiments, determining the weights is performed by using gradient descent, or any other suitable technique for determining weights. For example, weights w_{A} and w_{B} may be determined for the trained ML model, model A, and the second trained ML model, model B, respectively. At a later time, when a third trained ML model, model C (with weight w_{C}), is added to the ensemble, weights w_{A}, w_{B}, and w_{C} may be determined, using gradient descent or any other suitable technique for determining weights.

In some embodiments, the method further includes obtaining information about second training data used to generate the updated ML model. The second training data includes third inputs and corresponding third outputs. The information about the second training data includes a third representation of a third distribution of the third inputs and third performance data indicative of a measure of performance of the updated ML model on the third inputs. The method further includes obtaining information about second new data to which the updated ML model was applied. The second new data includes fourth inputs and corresponding fourth outputs. The information about the second new data includes a fourth representation of a fourth distribution of the fourth inputs and fourth performance data indicative of the measure of performance of the updated ML model on the fourth inputs. The method further includes determining, using the third representation, the fourth representation, the third performance data, and the fourth performance data, whether to further update the updated ML model or to generate a further supplemental ML model to use with the updated ML model. When it is determined to further update the updated ML model or to generate the further supplemental ML model to use with the updated ML model, the method further includes updating the updated ML model or generating the further supplemental ML model.

In some embodiments, the second training data includes the training data and the new data. In some embodiments, the second training data includes at least some of the training data. In some embodiments, the second training data includes at least some of the new data. In some embodiments, the second training data includes at least some of the training data and at least some of the new data.

In some embodiments, it is determined to generate a supplemental ML model to use with the trained ML model. In such embodiments, the act of determining whether to update the trained ML model or to generate a supplemental ML model to use with the trained ML model includes determining to generate the supplemental ML model to use with the trained ML model. Further, the act of updating the trained ML model or generating the supplemental ML model, when it is determined to update the trained ML model or to generate the supplemental ML model, includes generating the supplemental ML model. In some embodiments, the supplemental ML model may be trained on some or all of the training data and/or some or all of the new data. For example, the supplemental ML model may be trained on training data and/or new data from a portion of the input data domain where the trained ML model has poor performance (e.g., model performance not below a threshold error level, or any other suitable indicator of poor model performance). The input data domain may be partitioned into a first portion, for which the trained ML model when applied to input data does not have poor performance, and a second portion, for which the trained ML model when applied to input data has poor performance. The supplemental ML model may be assigned to the second portion of the input data domain. The supplemental ML model may be used to generate ML output for input data that falls in its assigned portion of the input data domain. The trained ML model may be assigned to the first portion of the input data domain. The trained ML model may be used to generate ML output for input data that falls in its assigned portion of the input data domain.

In some embodiments, generating the supplemental ML model includes training, using at least some of the new data, the supplemental ML model, associating the trained ML model with a first portion of an input data domain, and associating the supplemental ML model with a second portion of the input data domain. For example, the second portion of the input data domain associated with the supplemental ML model may be a part of the input data domain where the trained ML model has poor performance. The supplemental ML model may show better performance than the trained ML model on this part of the input data domain.

In some embodiments, the method further includes obtaining new input data and determining whether the new input data is in the first portion of the input data domain or in the second portion of the input data domain. When it is determined that the new input data is in the first portion of the input data domain, the method further includes providing the new input data as input to the trained ML model to obtain a first corresponding output. When it is determined that the new input data is in the second portion of the input data domain, the method further includes providing the new input data as input to the supplemental ML model to obtain a second corresponding output.

In some embodiments, the method further includes monitoring performance of the trained ML model and the supplemental ML model and, based on results of the monitoring, adjusting portions of the input data domain associated with the trained ML model and the supplemental ML model.

In some embodiments, the act of adjusting the portions includes adjusting a boundary between the first portion of the input data domain and the second portion of the input data domain thereby changing the first portion and the second portion of the input data domain. For example, the trained ML model may be associated with the first portion of the input data domain, input<2.5 or 3.0<=input, and the supplemental ML model may be associated with the second portion of the input data domain, 2.5<=input<3.0. The boundary between the first portion and the second portion may have been determined in a manner that maximizes distance between inputs for the trained ML model and the supplemental ML model (e.g., similar to a support vector machine algorithm that takes as input data with two classes and outputs a boundary or hyperplane that maximizes the margin between the two classes). In the example, the boundary between the first portion and the second portion is determined to be input=2.5. However, while monitoring performance of the trained ML model and the supplemental ML model, inputs close to the boundary, e.g., 2.47, 2.48, 2.49, etc., may be received, and the results of the monitoring may indicate that the supplemental ML model may have higher accuracy than the trained ML model on these inputs. Based on these results, the boundary between the first portion and the second portion may be adjusted to be input=2.45, in order to improve overall accuracy for the trained ML model and the supplemental ML model across the entire input data domain. After the boundary is adjusted, the first portion of the input data domain associated with the trained ML model may be changed to input<2.45 or 3.0<=input, and the second portion of the input data domain associated with the supplemental ML model may be changed to 2.45<=input<3.0.

In some embodiments, the method further includes obtaining information about second training data used to generate the supplemental ML model. The second training data includes third inputs and corresponding third outputs. The information about the second training data includes a third representation of a third distribution of the third inputs and third performance data indicative of a measure of performance of the supplemental ML model on the third inputs. The method further includes obtaining information about second new data to which the supplemental ML model was applied. The second new data includes fourth inputs and corresponding fourth outputs. The information about the second new data includes a fourth representation of a fourth distribution of the fourth inputs and fourth performance data indicative of the measure of performance of the supplemental ML model on the fourth inputs. The method further includes determining, using the third representation, the fourth representation, the third performance data, and the fourth performance data, whether to further update the supplemental ML model or to generate a second supplemental ML model to use with the trained ML model and the supplemental ML model. When it is determined to further update the supplemental ML model or to generate the second supplemental ML model to use with the trained ML model and the supplemental ML model, the method further includes updating the supplemental ML model or generating the second supplemental ML model.

In some embodiments, the first representation of the first distribution of the first inputs includes a histogram having multiple bins and counts corresponding to the bins. Each of the counts indicates how many of the first inputs fall into a respective bin in the multiple bins.

In some embodiments, the first performance data indicative of the measure of performance of the trained ML model on the first inputs includes, for each bin of at least some of the multiple bins, a measure of average error by the trained ML model when applied to inputs, among the first inputs, that fall in the bin.

In some embodiments, prior to obtaining the information about the new data, the method further includes applying the trained ML model to the second inputs to obtain the second outputs.

In some embodiments, prior to obtaining the information about the training data, the method further includes training, using the first inputs and the first outputs, an untrained ML model to generated the trained ML model.

In some embodiments, the act of determining, using the first representation, the second representation, the first performance data, and the second performance data, whether to update the trained ML model or to generate a supplemental ML model is performed based on a comparison between the first representation and the second representation.

In some embodiments, the act of comparing the first representation and second representation includes determining a Kullback-Liebler (KL) divergence between the first representation and the second representation.

In some embodiments, the act of determining, using the first representation, the second representation, the first performance data, and the second performance data, whether to update the trained ML model or to generate a supplemental ML model is performed further based on a comparison between the first performance data and the second performance data. In some embodiments, performing the comparison between the first performance data and the second performance data includes determining a KL divergence between the first performance data and the second performance data.

In some embodiments, the act of determining, using the first representation, the second representation, the first performance data, and the second performance data, whether to update the trained ML model or to generate a supplemental ML model includes determining a first value based on the comparison between the first representation and the second representation, determining a second value based on the comparison between the first performance data and the second performance data, and determining, based on a weighted combination of the first value and the second value, whether to update the trained ML model or to generate a supplemental ML model to use with the trained ML model.

In some embodiments, the first representation includes a first histogram having first counts for multiple bins. The second representation includes a second histogram having second counts for the multiple bins. The first performance data includes, for each bin of at least some of the bins, a measure of error incurred by the trained ML model when applied to inputs, among the first inputs, that fall in the bin. The second performance data includes, for each bin of at least some of the bins, a measure of error incurred by the trained ML model when applied to inputs, among the second inputs, that fall in the bin.

In some embodiments, the act of determining whether to update the trained ML model or to generate a supplemental ML model includes determining a number of bins, among the multiple bins, for which a difference between measures of error specified by the first performance data and the second performance data exceeds an average difference between the measures of error across the bins. The act of determining further includes determining to update the trained ML model when the number of bins exceeds a pre-determined threshold number of bins. The act of determining further includes determining to generate a supplemental ML model when the number of bins is less or equal to the pre-determined threshold number of bins. In some embodiments, the supplemental ML model is generated for the portion of the input data domain that includes the bins for which the error exceeded the average.

In some embodiments, the trained ML model comprises a linear regression model or a non-linear regression model (e.g., neural networks, support vector machines, or any other suitable non-linear regression model).

In some embodiments, the trained ML model includes an ML model configured to map inputs to outputs in a finite set of outputs corresponding to classification labels (e.g., object types detected in an input image, or any other suitable classification labels) or actions (e.g., whether to send a promotional message to a customer, or any other suitable action).

In some embodiments, prior to obtaining the information about the new data, the method further includes identifying at least some of the second inputs for which corresponding ground truth values are to be obtained. In some embodiments, the act of identifying at least some of the second inputs for which corresponding ground truth values are to be obtained is performed based on the first representation of the first distribution of the first inputs. For example, based on histogram for the distribution of the first inputs, inputs that are underrepresented in the histogram may be identified and selected as inputs for which corresponding ground truth values are to be obtained.

In some embodiments, the first representation of the first distribution of the first inputs includes a first histogram having multiple bins. The second representation of the second distribution of the second inputs includes a second histogram having the multiple bins. The method further includes identifying, using the first representation, the second representation, the first performance data and the second performance data, one or more bins for which to obtain additional inputs and corresponding ground truth values for improving performance of the trained ML model.

In some embodiments, the bins for which to obtain additional inputs and corresponding ground truth values may be identified to verify a trend. For example, a given bin for the training data may represent 9% of the training data and have an average error of 2%. However, in recently received new data, the bin may represent 15% of the new data and have a higher average error of 4%. If there is a trend in a certain direction away from what is represented by the training data, such a trend, if confirmed, may indicate that the model adapting techniques (e.g., a boost ML model or a supplemental ML model) should be applied.

Based on a histogram for the training data and training performance data per bin in the training data histogram, a histogram for the new data and new performance data per bin in the new data histogram, and how much data is observed per bin (i.e., data points represented by each bin compared to the total number of data points), a score to prioritize collection of additional inputs and corresponding ground truth values for certain bins may be determined:

score[i]=1/(similarity of training data histogram and new data histogram[i]*similarity of training performance data and new performance data[i]*frequency of observed data[i]),

where the similarity of the training data histogram and the new data histogram may be a KL divergence between the two histograms, the similarity of the training performance data and the new performance data may be a KL divergence between the two performance data, and frequency of observed data may be a ratio of the bin count and total count of the training data and the new data.

The set of scores for the bins may be analyzed to identify one or more bins for obtaining additional inputs and corresponding ground truth values. The additional inputs may be identified from a selected bin using random sampling, uniform sampling, or any other suitable sampling, and corresponding ground truth values may be requested for that sample of additional inputs. Once received, the additional inputs and corresponding ground truth values may be used to verify the trend and determine whether to apply any of the model adapting techniques described herein.

In some embodiments, an output of an ML model may be used to determine what additional inputs and ground truth values to collect to improve model performance. For example, the output of the ML model may predict whether a customer will respond to a survey. Customers may be represented by a vector of variable values (e.g., gender, ZIP code, age, number of purchases made in the last 6 months, number of times visited website in the last 6 months, etc.) to predict whether they will respond (e.g., Yes/No) to a survey. In one approach, an existing ML model may be used to make a prediction of whether the customer will respond and an action to send the survey to the customer may be taken based on the prediction. However, this may not work well because the existing ML model may have been trained on customer data that is not representative of present day customers. In another approach, some of the time, the action may be taken according to the ML model output, and other times (e.g., 5% of the time, or any other suitable frequency) the ML model output may be changed randomly to get new data representative of potentially unexplored parts of the input data domain. This approach may produce new data that is quite different from the training data originally used to train the ML model. Histograms and performance data for the training data and the new data may be analyzed to determine whether to apply any of the model adapting techniques described herein.

In some embodiments, performance data for an ML model indicates a measure of performance of the ML model on input data. The measure of performance may be average error, absolute deviation, mean squared error, root mean squared error, mean absolute scaled error, mean absolute percentage error, or any other suitable measure of performance. Thus, it should be appreciated that the measure of performance may be of any suitable type, as aspects of the technology described herein are not limited in this respect.

Following below are more detailed descriptions of various concepts related to, and embodiments of, techniques for adapting ML models. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

FIG. 1 shows block diagram 100 illustrating techniques for adapting an ML model (e.g., ML model 132, or any other suitable ML model). The described techniques may be implemented in a virtualized application program (e.g., virtualized application 140, or any other suitable virtualized ML application program) executing using at least one computer hardware processor (e.g., processor 802 in FIG. 8, or any other suitable processor). In some embodiments, a virtualized application program may be any application program configured to execute on a virtual machine (e.g., a VMWARE virtual machine, an AZURE virtual machine, etc.). In some embodiments, a virtualized application program may be a containerized application program configured to execute in a container such as a DOCKER container, a MOBY container, etc. In some embodiments, any suitable portion of the described techniques may be implemented in virtualized application 140 or at a computing system external to virtualized application 140. Thus, it should be appreciated that any such variations are within the scope of the techniques described herein and aspects of the technology described herein are not limited in this respect.

ML model 132 may be stored in inference module 130, or any other suitable location. ML model 132 may be a trained ML model (e.g., a linear regression model, a non-linear regression model such as neural networks, support vector machines, etc., or any other suitable ML model) generated using training data 104. In some embodiments, training data 104 may be included in virtualized application 140. In some embodiments, training data 104 may be accessed from a source external to virtualized application 140. For example, the source external to virtualized application 140 may be a data store, a relational database, an object oriented database, a flat file, Hadoop, or any other suitable source of data.

New data 102 may be provided to virtualized application 140. ML model 132 may perform poorly on new data 102 because ML model 132 was not trained on any data from that portion of the input data domain to which new data 102 belongs. For example, training data 104 may have examples from a portion of the input data domain different from that of new data 102.

Module 110 may receive new data 102. Module 110 may be configured to obtain information about new data 102, information about training data 104 used to generate ML model 132, and/or information about any other suitable data. Module 110 may include code 112 for obtaining a representation (e.g., a histogram, a kernel density estimate, or any other suitable representation) of a distribution of inputs in received data. Module 110 may further include code 114 for obtaining performance data indicative of a measure of performance (e.g., a measure of average error, a measure of mean squared error, or any other suitable measure of performance) of ML model 132 on the inputs in the received data. In some embodiments, module 110 may obtain information about the received data from a source external to virtualized application 140. In some embodiments, module 110 may determine information about the received data by executing code 112, code 114, and/or any other suitable code within virtualized application 140.

Training data 104 may include first inputs and corresponding first outputs. New data 102 may include second inputs and corresponding second outputs. Module 110 may obtain information about training data 104 including a first representation (e.g., a first histogram, a first kernel density estimate, or any other suitable representation) of a first distribution of the first inputs and first performance. Module 110 may obtain information about new data 102 to which the trained ML model was applied. The information about new data 102 may include a second representation (e.g., a second histogram, a second kernel density estimate, or any other suitable representation) of a second distribution of the second inputs and second performance data indicative of the measure of performance of ML model 132 on the second inputs.

Model auto evolution module 120 may include code for determining whether to adapt ML model 132, and if it is determined to adapt ML model 132, determining, using the first representation, the second representation, the first performance data, and/or the second performance data, whether to update ML model 132 or to generate a supplemental ML model to use with ML model 132. Model auto evolution module 120 may include code 122 for updating an ML model. For example, model auto evolution module 120 may execute code 122 to train a boost ML model and generate an updated ML model as an ensemble of ML model 132 and the boost ML model. In some embodiments, the output of the updated ML model may be a weighted combination of outputs from ML model 132 and the boost ML model. Model auto evolution module 120 may include code 124 for generating a supplemental ML model. For example, model auto evolution module 120 may execute code 124 to generate a supplemental ML model to use with ML model 132 (e.g., either ML model 132 or the supplemental ML model may be used depending on where provided input falls in the input data domain). The adapted ML model may be stored in inference module 130, or any other suitable location.

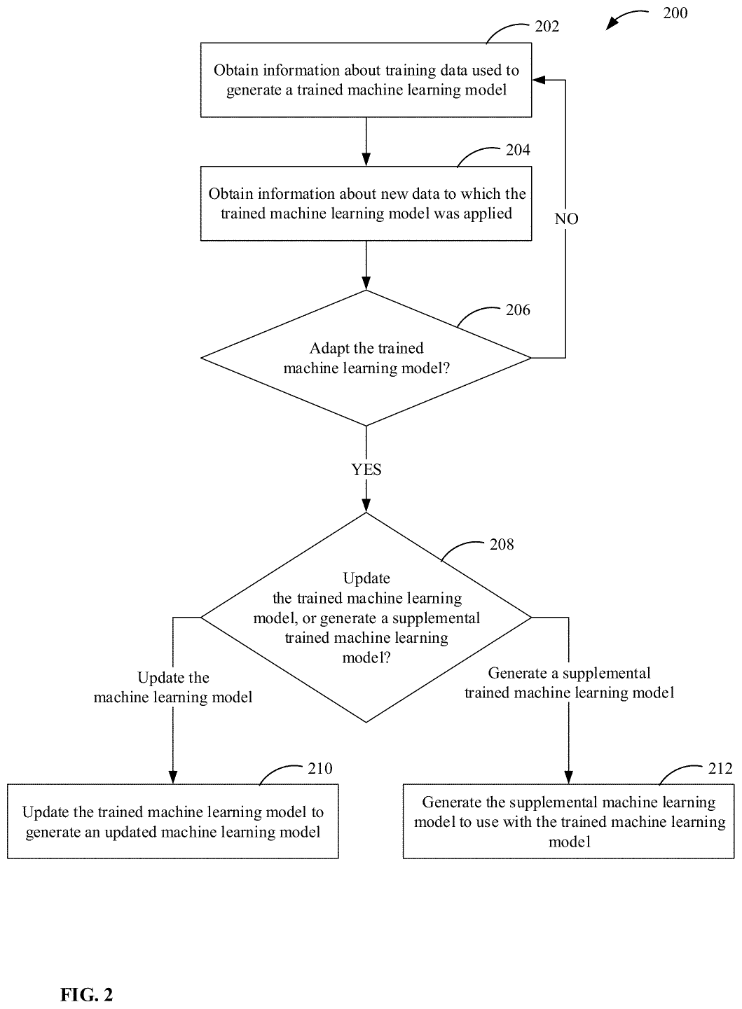

FIG. 2 is a flowchart of process 200 for adapting an ML model. At least some of the acts of process 200 may be performed by any suitable computing device(s) and, for example, may be performed by one or more of processor(s) 802 shown in computing system 800 of FIG. 8.

In act 202, process 200 obtains information about training data (e.g., training data 104 in FIG. 1, or any other suitable data) used to generate a trained ML model (e.g., ML model 132 in FIG. 1, or any other suitable ML model). In some embodiments, the training data may include first inputs and corresponding first outputs. The information about the training data may include a first representation (e.g., a first histogram, a first kernel density estimate, or any other suitable representation) of a first distribution of the first inputs and first performance data indicative of a measure of performance (e.g., a measure of average error, a measure of mean squared error, or any other suitable measure of performance) of the trained ML model on the first inputs.

After act 202, process 200 proceeds to act 204, where process 200 obtains information about new data (e.g., new data 102 in FIG. 1, or any other suitable data) to which the trained ML model was applied. The new data may include second inputs and corresponding second outputs. The information about the new data may include a second representation (e.g., a second histogram, a second kernel density estimate, or any other suitable representation) of a second distribution of the second inputs and second performance data indicative of the measure of performance of the trained ML model on the second inputs.

In some embodiments, the new data may provide ground truth outputs for previous inputs on which the trained ML model was applied to generate ML outputs. In some embodiments, the new data may include additional training data from recent customers to which the trained ML model has not yet been applied. In some embodiments, the new data may be obtained by using previous output of the trained ML model to determine what additional inputs and ground truth values to include in the new data. For example, the output of the trained ML model may predict whether a customer will respond to a survey. Customers may be represented by a vector of variable values (e.g., gender, ZIP code, age, number of purchases made in the last 6 months, number of times visited website in the last 6 months, etc.) to predict whether they will respond (e.g., Yes/No) to a survey. In one approach, the trained ML model may be used to make a prediction of whether the customer will respond and an action to send the survey to the customer may be taken based on the prediction. However, this may not work well because the trained ML model may have been trained on customer data that is not representative of present day customers. In another approach, some of the time, the action may be taken according to output of the trained ML model, and other times (e.g., 5% of the time, or any other suitable frequency) the output of the trained ML model may be changed randomly to get new data representative of potentially unexplored parts of the input data domain. This approach may produce new data that is quite different from the training data originally used to train the trained ML model.

After act 204, process 200 proceeds to act 206, where process 200 determines whether to adapt the trained ML model. In some embodiments, process 200 may determine whether to adapt the trained ML model based on the model performance being below or not below a specified error threshold. In some embodiments, process 200 may determine whether to adapt the trained ML model based on a periodic interval (e.g., every week, every month, every two months, or any other suitable interval). In some embodiments, process 200 may determine whether to adapt the trained ML model based on when a threshold amount (e.g., 20% of the size of the training data initially used to generate the trained ML model, 50% of the size of the training data initially used to generate the trained ML model, or any other suitable threshold) of new data is available.

After act 206, when it is determined to not adapt the trained ML model, process 200 proceeds to act 202. For example, process 200 may determine to not adapt the trained ML model because the model performance is below a specified error threshold. In another example, process 200 may determine to not adapt the trained ML model because the current time does not comply with a periodic interval for adapting the trained ML model. In yet another example, process 200 may determine to not adapt the trained ML model because new data may be received but may be less than a threshold amount of new data required to trigger adapting the trained ML model.

After act 206, when it is determined to adapt the trained ML model, process 200 proceeds to act 208. For example, process 200 may determine to adapt the trained ML model because the model performance is not below a specified error threshold. In another example, process 200 may determine to adapt the trained ML model because the current time complies with a periodic interval for adapting the trained ML model. In yet another example, process 200 may determine to adapt the trained ML model because the received new data may be more than a threshold amount of new data required to trigger adapting the trained ML model.

In act 208, process 200 determines, using the first representation, the second representation, the first performance data, and the second performance data, whether to update the trained ML model or to generate a supplemental ML model to use with the trained ML model. In some embodiments, a comparison between the first representation and the second representation may be performed. For example, the comparison may be performed by determining a KL divergence between the first representation and the second representation. In some embodiments, a comparison between the first performance data and the second performance data may be performed. For example, the comparison may be performed by determining a KL divergence between the first performance data and the second performance data. In some embodiments, a first value may be determined based on the comparison between the first representation and the second representation. For example, the first value may be based on the determined KL divergence for the two representations. In some embodiments, a second value may be determined based on the comparison between the first performance data and the second performance data. For example, the second value may be based on the determined KL divergence for the two performance data. In some embodiments, a third value may be determined based on a weighted combination of the first value and the second value. Based on the determined third value, it may be determined whether to update the trained ML model or to generate a supplemental ML model to use with the trained ML model.

After act 208, when it is determined to update the trained ML model, process 200 proceeds to act 210, where process 200 updates the trained ML model to generate an updated ML model (e.g., updated ML model 422 in FIG. 4A, or any other suitable ML model). In some embodiments, the trained ML model may be updated by generating a second trained ML model (e.g., a boost ML model, or any other suitable ML model) and generating an updated ML model as an ensemble of the trained ML model and the second trained ML model. In some embodiments, the second trained ML model may be a boost ML model generated using AdaBoost, XGBoost, Gradient Boosting Machine (GBM), or any other suitable boosting algorithm. In some embodiments, a boosting algorithm includes training the second trained ML model on some or all of the training data and/or some or all of the new data and adding the second trained ML model to an ensemble including the trained ML model which was trained on the training data. In some embodiments, when training the second trained ML model, input on which the trained ML model has low accuracy (e.g., the predicted outputs have average error higher than a threshold) is assigned a higher weight and input on which the trained ML model has high accuracy (e.g., the predicted outputs have average error lower than the threshold) is assigned a lower weight. Thus, the second trained ML model may focus more on input on which the trained ML model performed poorly.

In some embodiments, generating the updated ML model further includes determining weights for the trained ML model and the second trained ML model in the ensemble. For example, when the second trained ML model is added to the ensemble, the trained ML model and the second trained ML model are weighted in a way that improves overall accuracy for the ensemble. In some embodiments, determining the weights is performed by using gradient descent, or any other suitable technique for determining weights. For example, weights w_{A} and w_{B} may be determined for the trained ML model, model A, and the second trained ML model, model B, respectively.

After act 208, when it is determined to generate the supplemental ML model to use with the trained ML model, process 200 proceeds to act 212, where process 200 generates the supplemental ML model (e.g., supplemental ML model 520 in FIG. 5A, or any other suitable ML model) to use with the trained ML model. In some embodiments, the supplemental ML model may be trained on some or all of the training data and/or some or all of the new data. For example, the supplemental ML model may be trained on training data and/or new data from a portion of the input data domain where the trained ML model has poor performance. The input data domain may be partitioned into a first portion, for which the trained ML model when applied to input data does not have poor performance, and a second portion, for which the trained ML model when applied to input data has poor performance. The supplemental ML model may be assigned to the second portion of the input data domain. The supplemental ML model may be used to generate ML output for input data that falls in its assigned portion of the input data domain. The trained ML model may be assigned to the first portion of the input data domain. The trained ML model may be used to generate ML output for input data that falls in its assigned portion of the input data domain.

It should be appreciated that process 200 is illustrative and that there are variations. In some embodiments, one or more of the acts of process 200 may be optional or be performed in a different order than shown in FIG. 2. For example, act 202 and act 204 may be performed in a different order. Alternatively, act 202 and act 204 may be performed in parallel.

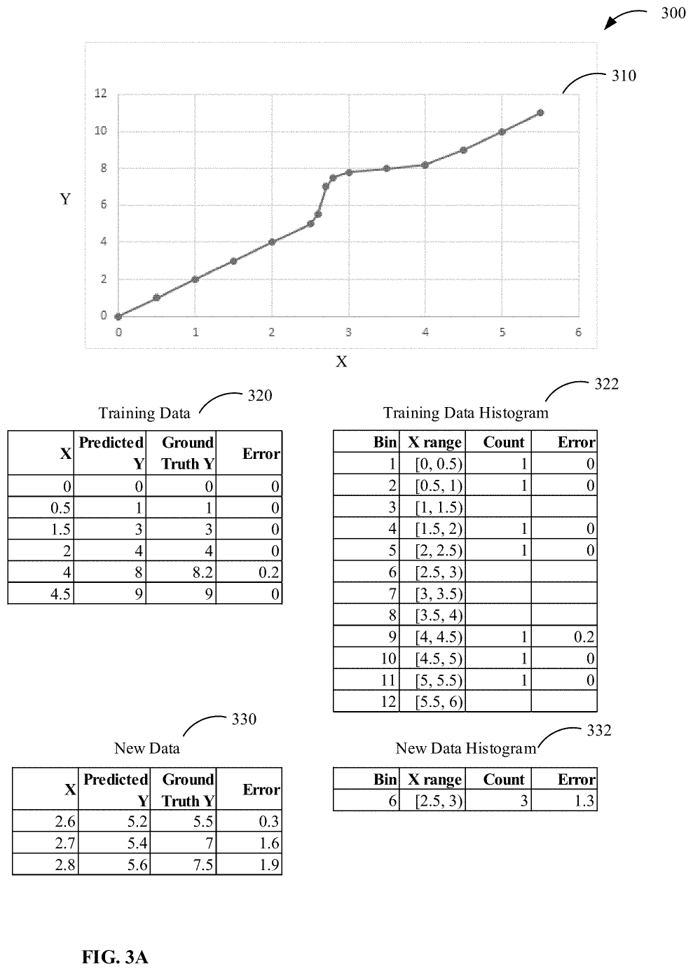

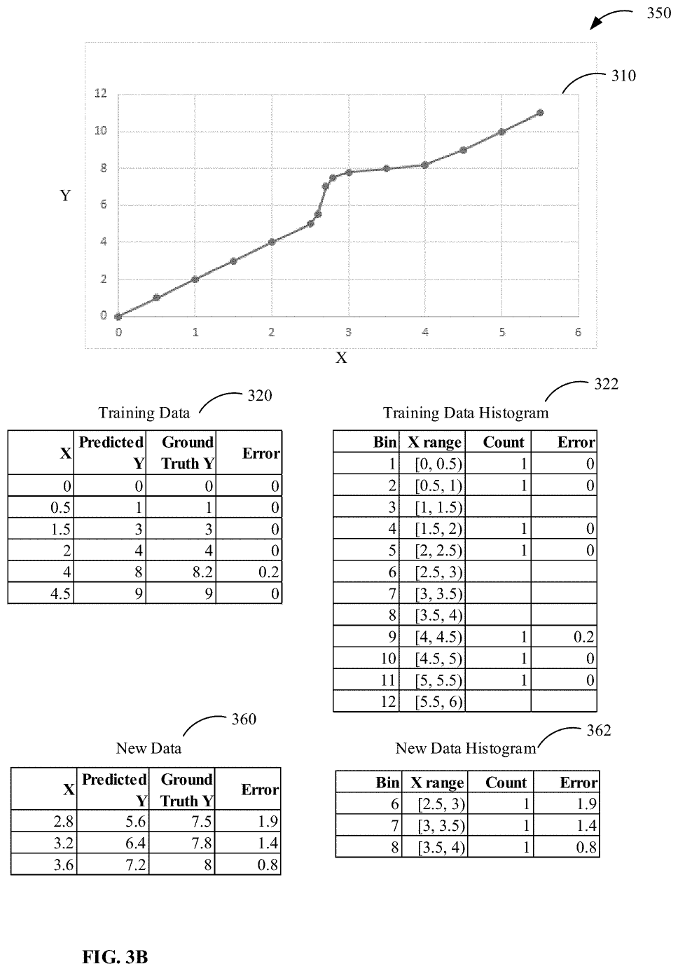

FIG. 3A shows illustrative example 300, where it is determined whether to adapt an ML model. Training data 320 may be received to train an ML model (e.g., ML model 132 in FIG. 1, or any other suitable ML model) to learn function 310. Training data 320 may include training inputs and corresponding training outputs. Information about training data 320 used to generate the trained ML model may obtained. For example, training data 320 may be provided to module 110 in FIG. 1, which includes code 112 for obtaining a representation of a distribution of inputs in training data 320 and code 114 for obtaining performance data indicative of a measure of performance of the trained ML model on the inputs in training data 320. The information about training data 320 may include a representation (e.g., training data histogram 322, or any other suitable representation) of a distribution of the training inputs and performance data indicative of a measure of performance (e.g., a measure of average error, a measure of mean squared error, or any other suitable measure of performance) of the trained ML model on the training inputs.

For example, the trained ML model may learn a linear function, Y=2X, based on training data 320. Training data histogram 322 may be generated based on the inputs and corresponding ML outputs, which may be obtained when the trained ML model is applied to the inputs. Training data histogram 322 may include multiple bins, bins 1-12, and counts corresponding to the bins. Each of the counts may indicate how many of the inputs fall into a respective bin from bins 1-12. Training data histogram 322 may have associated performance data indicative of the measure of performance of the trained ML model on the inputs. For the bins where inputs were provided in training data 320, training data histogram 322 may include a measure of average error by the trained ML model when applied to inputs that fall in the bin. For example, training data histogram 322 indicates the measure of average error by the trained ML model is zero when applied to inputs that fall in bin 1, but the measure of average error by the trained ML model is 0.2 when applied to inputs that fall in bin 9.

New data 330 may be received and provided to the trained ML model. New data 330 may include new inputs and corresponding new outputs. Information about new data 330 to which the trained ML model was applied may be obtained. For example, new data 330 may be provided to module 110 in FIG. 1, which includes code 112 for obtaining a representation of a distribution of inputs in new data 330 and code 114 for obtaining performance data indicative of a measure of performance of the trained ML model on the inputs in new data 330. The information about new data 330 may include a representation (e.g., new data histogram 332, or any other suitable representation) of a distribution of the new inputs and performance data indicative of the measure of performance (e.g., a measure of average error, a measure of mean squared error, or any other suitable measure of performance) of the trained ML model on the new inputs.

New data histogram 332 may be generated based on the inputs and corresponding ML outputs, which may be obtained when the trained ML model is applied to the inputs. New data histogram 332 may include one bin, bin 6, and a count corresponding to the bin. The count may indicate how many of the inputs fall into the bin. New data histogram 332 may have associated performance data indicative of the measure of performance of the trained ML model on the inputs. For the bins where inputs were provided in new data 330, which is bin 6 in this case, new data histogram 332 may indicate a measure of average error by the trained ML model when applied to inputs that fall in the bin. For example, new data histogram 332 indicates the measure of average error by the trained ML model is 1.3 when applied to inputs that fall in bin 6.

It may be determined whether to adapt the trained ML model. In some embodiments, it is determined to not adapt the trained ML model (e.g., it is determined neither to update the trained ML model nor to generate a supplemental ML model). For example, it may be determined to not adapt the trained ML model because new data 330 may be less than a threshold amount (e.g., 20% of the size of the training data initially used to generate the trained ML model, 50% of the size of the training data initially used to generate the trained ML model, or any other suitable threshold) of new data required to trigger adapting the trained ML model. In another example, it may be determined to not adapt the trained ML model because the model performance is below a specified error threshold (e.g., 2% error threshold, 5% error threshold, or any other suitable error threshold). In yet another example, it may be determined to not adapt the trained ML model because the current time does not comply with a periodic interval (e.g., every week, every month, every two months, or any other suitable interval) for adapting the trained ML model.

In some embodiments, it is determined to adapt the trained ML model. For example, it may be determined to adapt the trained ML model because new data 330 may be more than a threshold amount of new data required to trigger adapting the trained ML model. In another example, it may be determined to adapt the trained ML model because the model performance is not below a specified error threshold. In yet another example, it may be determined to adapt the trained ML model because the current time complies with a periodic interval for adapting the trained ML model.

It may be determined using training data histogram 322 and associated performance data and new data histogram 332 and associated performance data whether to update the trained ML model (e.g., train a boost ML model) or to generate a supplemental ML model to use with the trained ML model. In some embodiments, a comparison between training data histogram 322 and new data histogram 332 may be performed. For example, the comparison may be performed by determining a KL divergence between training data histogram 322 and new data histogram 332. In some embodiments, a comparison between performance data associated with training data histogram 322 and performance data associated with new data histogram 332 may be performed. For example, the comparison may be performed by determining a KL divergence between performance data associated with training data histogram 322 and performance data associated with new data histogram 332.

In some embodiments, a first value may be determined based on the comparison between training data histogram 322 and new data histogram 332. For example, the first value may be based on the determined KL divergence for the two histograms. In some embodiments, a second value may be determined based on the comparison between performance data associated with training data histogram 322 and performance data associated with new data histogram 332. For example, the second value may be based on the determined KL divergence for the two performance data. In some embodiments, a third value may be determined based on a weighted combination of the first value and the second value. Based on the determined third value, it may be determined whether to update the trained ML model or to generate a supplemental ML model to use with the trained ML model.

In some embodiments, among the multiple bins, a number of bins may be determined for which a difference between measures of error specified by performance data associated with training data histogram 322 and performance data associated with new data histogram 332 exceeds an average difference between the measures of error across the bins, which is one bin in this case. It may be determined to generate a supplemental ML model when the number of bins is less or equal to a pre-determined threshold number of bins (e.g., one bin, two bins, or any other suitable threshold). In some embodiments, module auto evolution module 120 may execute code 124 for generating a supplemental ML model to use with the trained ML model, or any other suitable code.

In some embodiments, the supplemental ML model may be trained on some or all of the training data and/or some or all of the new data. The supplemental ML model may be trained on training data and/or new data from a portion of the input data domain where the trained ML model has poor performance. For example, the supplemental ML model may be generated for the portion of the input data domain that includes the bins for which the error exceeded the average. The input data domain may be partitioned into a first portion, for which the trained ML model when applied to input data does not have poor performance, and a second portion, for which the trained ML model when applied to input data has poor performance. The supplemental ML model may be assigned to the second portion of the input data domain. The supplemental ML model may be used to generate ML output for input data that falls in its assigned portion of the input data domain. The trained ML model may be assigned to the first portion of the input data domain. The trained ML model may be used to generate ML output for input data that falls in its assigned portion of the input data domain. For example, the trained ML model may be associated with a first portion of the input data domain, input<2.5 or 3.0<=input, and the supplemental ML model may be associated with a second portion of the input data domain, 2.5<=input<3.0.

FIG. 3B shows illustrative example 350 where it is determined whether to adapt an ML model. Training data 320 may be received to train an ML model (e.g., ML model 132 in FIG. 1, or any other suitable ML model) to learn function 310. Training data 320 may include training inputs and corresponding training outputs. Information about training data 320 used to generate the trained ML model may obtained. For example, training data 320 may be provided to module 110 in FIG. 1, which includes code 112 for obtaining a representation of a distribution of inputs in training data 320 and code 114 for obtaining performance data indicative of a measure of performance of the trained ML model on the inputs in training data 320. The information about training data 320 may include a representation (e.g., training data histogram 322, or any other suitable representation) of a distribution of the training inputs and performance data indicative of a measure of performance (e.g., a measure of average error, a measure of mean squared error, or any other suitable measure of performance) of the trained ML model on the training inputs.

For example, the trained ML model may learn a linear function, Y=2X, based on training data 320. Training data histogram 322 may be generated based on the inputs and corresponding ML outputs, which may be obtained when the trained ML model is applied to the inputs. Training data histogram 322 may include multiple bins, bins 1-12, and counts corresponding to the bins. Each of the counts may indicate how many of the inputs fall into a respective bin from bins 1-12. Training data histogram 322 may have associated performance data indicative of the measure of performance of the trained ML model on the inputs. For the bins where inputs were provided in training data 320, training data histogram 322 may include a measure of average error by the trained ML model when applied to inputs that fall in the bin. For example, training data histogram 322 indicates the measure of average error by the trained ML model is zero when applied to inputs that fall in bin 1, but the measure of average error by the trained ML model is 0.2 when applied to inputs that fall in bin 9.

New data 360 may be received and provided to the trained ML model. New data 360 may include new inputs and corresponding new outputs. Information about new data 360 to which the trained ML model was applied may be obtained. For example, new data 360 may be provided to module 110 in FIG. 1, which includes code 112 for obtaining a representation of a distribution of inputs in new data 360 and code 114 for obtaining performance data indicative of a measure of performance of the trained ML model on the inputs in new data 360. The information about new data 360 may include a representation (e.g., new data histogram 362, or any other suitable representation) of a distribution of the new inputs and performance data indicative of the measure of performance (e.g., a measure of average error, a measure of mean squared error, or any other suitable measure of performance) of the trained ML model on the new inputs.

New data histogram 362 may be generated based on the inputs and corresponding ML outputs, which may be obtained when the trained ML model is applied to the inputs. New data histogram 362 may include three bins, bin 6, bin 7, and bin 8, and counts corresponding to the bins. The count for each bin may indicate how many of the inputs fall into the bin. New data histogram 362 may have associated performance data indicative of the measure of performance of the trained ML model on the inputs. For the bins where inputs were provided in new data 360, which is bin 6, bin 7, and bin 8 in this case, new data histogram 362 may indicate a measure of average error by the trained ML model when applied to inputs that fall in the bin. For example, new data histogram 362 indicates the measure of average error by the trained ML model is 1.9 when applied to inputs that fall in bin 6. Further, new data histogram 362 indicates the measure of average error by the trained ML model is 1.4 when applied to inputs that fall in bin 7. Finally, new data histogram 362 indicates the measure of average error by the trained ML model is 0.8 when applied to inputs that fall in bin 8.

It may be determined whether to adapt the trained ML model. In some embodiments, it is determined to not adapt the trained ML model (e.g., it is determined neither to update the trained ML model nor to generate a supplemental ML model). For example, it may be determined to not adapt the trained ML model because new data 360 may be less than a threshold amount (e.g., 20% of the size of the training data initially used to generate the trained ML model, 50% of the size of the training data initially used to generate the trained ML model, or any other suitable threshold) of new data required to trigger adapting the trained ML model. In another example, it may be determined to not adapt the trained ML model because the model performance is below a specified error threshold (e.g., 2% error threshold, 5% error threshold, or any other suitable error threshold). In yet another example, it may be determined to not adapt the trained ML model because the current time does not comply with a periodic interval (e.g., every week, every month, every two months, or any other suitable interval) for adapting the trained ML model.

In some embodiments, it is determined to adapt the trained ML model. For example, it may be determined to adapt the trained ML model because new data 360 may be more than a threshold amount of new data required to trigger adapting the trained ML model. In another example, it may be determined to adapt the trained ML model because the model performance is not below a specified error threshold. In yet another example, it may be determined to adapt the trained ML model because the current time complies with a periodic interval for adapting the trained ML model.

It may be determined using training data histogram 322 and associated performance data and new data histogram 362 and associated performance data whether to update the trained ML model (e.g., train a boost ML model) or to generate a supplemental ML model to use with the trained ML model. In some embodiments, a comparison between training data histogram 322 and new data histogram 362 may be performed. For example, the comparison may be performed by determining a KL divergence between training data histogram 322 and new data histogram 362. In some embodiments, a comparison between performance data associated with training data histogram 322 and performance data associated with new data histogram 362 may be performed. For example, the comparison may be performed by determining a KL divergence between performance data associated with training data histogram 322 and performance data associated with new data histogram 362.

In some embodiments, a first value may be determined based on the comparison between training data histogram 322 and new data histogram 362. For example, the first value may be based on the determined KL divergence for the two histograms. In some embodiments, a second value may be determined based on the comparison between performance data associated with training data histogram 322 and performance data associated with new data histogram 362. For example, the second value may be based on the determined KL divergence for the two performance data. In some embodiments, a third value may be determined based on a weighted combination of the first value and the second value. Based on the determined third value, it may be determined whether to update the trained ML model or to generate a supplemental ML model to use with the trained ML model.

In some embodiments, among the multiple bins, a number of bins may be determined for which a difference between measures of error specified by performance data associated with training data histogram 322 and performance data associated with new data histogram 362 exceeds an average difference between the measures of error across the bins, which is three bins in this case. It may be determined to update the trained ML model when the number of bins exceeds a pre-determined threshold number of bins (e.g., one bin, two bins, or any other suitable threshold). In some embodiments, module auto evolution module 120 may execute code 122 for updating the trained ML model, or any other suitable code.

In some embodiments, the trained ML model may be updated by generating a second trained ML model (e.g., a boost ML model, or any other suitable ML model) and generating an updated ML model as an ensemble of the trained ML model and the second trained ML model. In some embodiments, the second trained ML model may be a boost ML model generated using AdaBoost, XGBoost, Gradient Boosting Machine (GBM), or any other suitable boosting algorithm. In some embodiments, a boosting algorithm includes training the second trained ML model on some or all of the training data and/or some or all of the new data and adding the second trained ML model to an ensemble including the trained ML model which was trained on the training data. In some embodiments, when training the second trained ML model, input on which the trained ML model has low accuracy (e.g., the predicted outputs have average error higher than a threshold) is assigned a higher weight and input on which the trained ML model has high accuracy (e.g., the predicted outputs have average error lower than the threshold) is assigned a lower weight. Thus, the second trained ML model may focus more on input on which the trained ML model performed poorly.

In some embodiments, generating the updated ML model further includes determining weights for the trained ML model and the second trained ML model in the ensemble. For example, when the second trained ML model is added to the ensemble, the trained ML model and the second trained ML model are weighted in a way that improves overall accuracy for the ensemble. In some embodiments, determining the weights is performed by using gradient descent, or any other suitable technique for determining weights. For example, weights w_{A} and w_{B} may be determined for the trained ML model, model A, and the second trained ML model, model B, respectively.

FIG. 4A shows block diagram 400 illustrating ML model 410 and updated ML model 422 as an ensemble of ML model 410 and boost ML model 420. Boost ML model 420 may be generated using AdaBoost, XGBoost, Gradient Boosting Machine (GBM), or any other suitable boosting algorithm. In some embodiments, a boosting algorithm includes training boost ML model 420 on some or all of training data on which ML model 410 was trained and/or some or all of new data on which ML model 410 has not been trained. When boost ML model 420 is added to the ensemble for updated ML model 422, ML model 410 and boost ML model 420 may be weighted (e.g., using a gradient descent algorithm, or any other suitable algorithm) in a way that improves overall accuracy for the ensemble. For example, weights w_{A} and w_{B} may be determined for ML model 410 and boost ML model 420, respectively. In some embodiments, when training boost ML model 420, input on which ML model 410 has low accuracy (e.g., the predicted outputs have average error higher than a threshold) is assigned a higher weight and input on which ML model 410 has high accuracy (e.g., the predicted outputs have average error lower than the threshold) is assigned a lower weight. Thus, boost ML model 420 may focus more on input on which ML model 410 performed poorly.

FIG. 4B is a flowchart of process 450 for adapting an ML model (e.g., ML model 410 in FIG. 4A, or any other suitable ML model). At least some of the acts of process 450 may be performed by any suitable computing device(s) and, for example, may be performed by one or more of processor(s) 802 shown in computing system 800 of FIG. 8.

In act 452, process 450 trains, using at least some of new data (e.g., new data 360 in FIG. 3B, or any other suitable data), a second trained ML model (e.g., boost ML model 420 in FIG. 4A, or any other suitable ML model). In some embodiments, the second trained ML model may be a boost ML model generated using AdaBoost, XGBoost, Gradient Boosting Machine (GBM), or any other suitable boosting algorithm. In some embodiments, a boosting algorithm includes training the second trained ML model on some or all of the training data and/or some or all of the new data. In some embodiments, when training the second trained ML model, input on which the trained ML model has low accuracy (e.g., the predicted outputs have average error higher than a threshold) is assigned a higher weight and input on which the trained ML model has high accuracy (e.g., the predicted outputs have average error lower than the threshold) is assigned a lower weight. Thus, the second trained ML model may focus more on input on which the trained ML model performed poorly.

After act 452, process 450 proceeds to act 454, where process 450 determines weights for a trained ML model (e.g., ML model 410 in FIG. 4A, or any other suitable ML model) and the second trained ML model in the ensemble. For example, when the second trained ML model is added to the ensemble, the trained ML model and the second trained ML model are weighted in a way that improves overall accuracy for the ensemble. In some embodiments, process 450 may determine the weights by using gradient descent, or any other suitable technique for determining weights. For example, weights w_{A} and w_{B} may be determined for the trained ML model and the second trained ML model, respectively.

After act 454, process 450 proceeds to act 456, where process 450 generates an updated ML model (e.g., updated ML model 422 in FIG. 4A, or any other suitable ML model) as an ensemble of the trained ML model and the second trained ML model. In some embodiments, the output of the updated ML model may be a weighted combination of outputs from the trained ML model and the second trained ML model. For example, the output of the updated ML model may be determined using weights w_{A} and w_{B} assigned to the trained ML model and the second trained ML model, respectively.

It should be appreciated that process 450 is illustrative and that there are variations. In some embodiments, one or more of the acts of process 450 may be optional or be performed in a different order than shown in FIG. 4B. For example, act 454 may be optional.

FIG. 5A shows block diagram 500 illustrating ML model 510 and supplemental ML model 520 to use with ML model 510. Initially, ML model 510 may be applied to inputs from the entirety of the input data domain. In some embodiments, supplemental ML model 520 may be trained on some or all of training data used to train ML model 510 and/or some or all of new data on which ML model 510 has not yet been trained. For example, the supplemental ML model may be trained on training data and/or new data from a portion of the input data domain where the trained ML model has poor performance (e.g., model performance not below a threshold error level, or any other suitable indicator of poor model performance).

After supplemental ML model 520 is trained, the input data domain may be partitioned into portion 512, for which ML model 510 when applied to input data does not have poor performance (e.g., average error below a threshold, or any other suitable indicator of performance), and portion 522, for which ML model 510 when applied to input data has poor performance (e.g., average error not below the threshold, or any other suitable indicator of performance). Supplemental ML model 520 may be assigned to portion 522 of the input data domain. Supplemental ML model 520 may be used to generate ML output for input data that falls in portion 522 of the input data domain. Supplemental ML model 520 may show better performance than ML model 510 on this part of the input data domain. ML model 510 may be assigned to portion 512 of the input data domain. ML model 510 may be used to generate ML output for input data that falls in portion 512 of the input data domain.

In some embodiments, performance of ML model 510 and supplemental ML model 520 may be monitored and, based on results of the monitoring, portions of the input data domain associated with ML model 510 and supplemental ML model 520 may be adjusted. For example, while monitoring performance of ML model 510 and supplemental ML model 520, inputs close to a boundary between portion 512 and portion 522 of the input data domain may be received. The results of the monitoring may indicate that supplemental ML model 520 may have higher accuracy than ML model 510 on these inputs. Based on these results, the boundary between portion 512 and portion 522 of the input data domain may be adjusted in order to improve overall accuracy for ML model 510 and supplemental ML model 520 across the entire input data domain.

For example, ML model 510 may be associated with a first portion of input data domain, and supplemental ML model 520 may be associated with a second portion of the input data domain. The boundary between the first portion and the second portion may have been determined in a manner that maximizes distance between inputs for ML model 510 and supplemental ML model 520 (e.g., similar to a support vector machine algorithm that takes as input data with two classes and outputs a boundary or hyperplane that maximizes the margin between the two classes). However, while monitoring performance of ML model 510 and supplemental ML model 520, inputs close to the boundary may be received, and the results of the monitoring may indicate that supplemental ML model 520 may have higher accuracy than ML model 510 on these inputs. Based on these results, the boundary between the first portion and the second portion may be adjusted to add these inputs close to the boundary to the second portion of the input data domain, in order to improve overall accuracy for ML model 510 and supplemental ML model 520 across the entire input data domain. Alternatively, if the results of the monitoring may indicate that supplemental ML model 520 may have lower accuracy than ML model 510 on these inputs, the boundary between the first portion and the second portion may be adjusted to add these inputs close to the boundary to the first portion of the input data domain.

When new input data is received, it is determined whether the new input data is in portion 512 of the input data domain or in portion 522 of the input data domain. When it is determined that the new input data is in portion 512 of the input data domain, the new input data may be provided as input to ML model 510 to obtain corresponding ML output. When it is determined that the new input data is in portion 522 of the input data domain, the new input data may be provided as input to supplemental ML model 520 to obtain corresponding ML output.

FIG. 5B is a flowchart of process 530 for adapting an ML model (e.g., ML model 510 in FIG. 5A, or any other suitable ML model). At least some of the acts of process 530 may be performed by any suitable computing device(s) and, for example, may be performed by one or more of processor(s) 802 shown in computing system 800 of FIG. 8.

In act 532, process 530 trains, using at least some of new data (e.g., new data 360 in FIG. 3B, or any other suitable data), a supplemental ML model (e.g., supplemental ML model 520 in FIG. 5A, or any other suitable ML model). In some embodiments, the supplemental ML model may be trained on some or all of training data on which a trained ML model was trained and/or some or all of new data on which the trained ML model has not yet been trained. For example, the supplemental ML model may be trained on training data and/or new data from a portion of the input data domain where the trained ML model has poor performance (e.g., model performance not below a threshold error level, or any other suitable indicator of poor model performance).

After act 532, process 530 proceeds to act 534, where process 530 associates a trained ML model (e.g., ML model 510 in FIG. 5A, or any other suitable ML model) with a first portion (e.g., portion 512 in FIG. 5A, or any other suitable portion) of an input data domain. In some embodiments, the input data domain may be partitioned into a first portion, for which the trained ML model when applied to input data does not have poor performance, and a second portion, for which the trained ML model when applied to input data has poor performance. The trained ML model may be associated with the first portion of the input data domain. The trained ML model may be used to generate ML output for input data that falls in its assigned portion of the input data domain.

After act 534, process 530 proceeds to act 536, where process 530 associates the supplemental ML model with a second portion (e.g., portion 522 in FIG. 5A, or any other suitable portion) of the input data domain. In some embodiments, the second portion of the input data domain associated with the supplemental ML model may be a part of the input data domain where the trained ML model has poor performance. The supplemental ML model may show better performance than the trained ML model on this part of the input data domain. The supplemental ML model may be used to generate ML output for input data that falls in its assigned portion of the input data domain.

It should be appreciated that process 530 is illustrative and that there are variations. In some embodiments, one or more of the acts of process 530 may be optional or be performed in a different order than shown in FIG. 5B. For example, act 534 and act 536 may be performed in a different order. Alternatively, act 534 and act 536 may be performed in parallel.

FIG. 5C is a flowchart of process 550 for determining whether to provide new input data to an ML model or a supplemental ML model. At least some of the acts of process 550 may be performed by any suitable computing device(s) and, for example, may be performed by one or more of processor(s) 802 shown in computing system 800 of FIG. 8.

In act 552, process 550 obtains new input data. The input data domain from which new input data is obtained may be partitioned into a first portion (e.g., portion 512 in FIG. 5A, or any other suitable portion) of the input data domain, for which the ML model when applied to input data does not have poor performance, and a second portion (e.g., portion 522 in FIG. 5A, or any other suitable portion) of the input data domain, for which the ML model when applied to input data has poor performance.

After act 552, process 550 proceeds to act 554, where process 550 determines whether the new input data is in the first portion (e.g., portion 512 in FIG. 5A, or any other suitable portion) of the input data domain or in the second portion (e.g., portion 522 in FIG. 5A, or any other suitable portion) of the input data domain. The ML model may be assigned to the first portion of the input data domain. The supplemental ML model may be assigned to the second portion of the input data domain. In some embodiments, the supplemental ML model may show better performance than the ML model on the second portion of the input data domain.

After act 554, when it is determined that the new input data is in the first portion of the input data domain, process 550 proceeds to act 556, where process 550 provides the new input data as input to the ML model (e.g., ML model 510 in FIG. 5A, or any other suitable ML model) to obtain a first corresponding output. The ML model may be used to generate ML output for new input data that falls in the first portion of the input data domain.

After act 554, when it is determined that the new input data is in the second portion of the input data domain, process 550 proceeds to act 558, where process 550 provides the new input data as input to the supplemental ML model (e.g., supplemental ML model 520 in FIG. 5A, or any other suitable ML model) to obtain a second corresponding output. The supplemental ML model may be used to generate ML output for new input data that falls in the second portion of the input data domain.

It should be appreciated that process 550 is illustrative and that there are variations. In some embodiments, one or more of the acts of process 550 may be optional or be performed in a different order than shown in FIG. 5C.

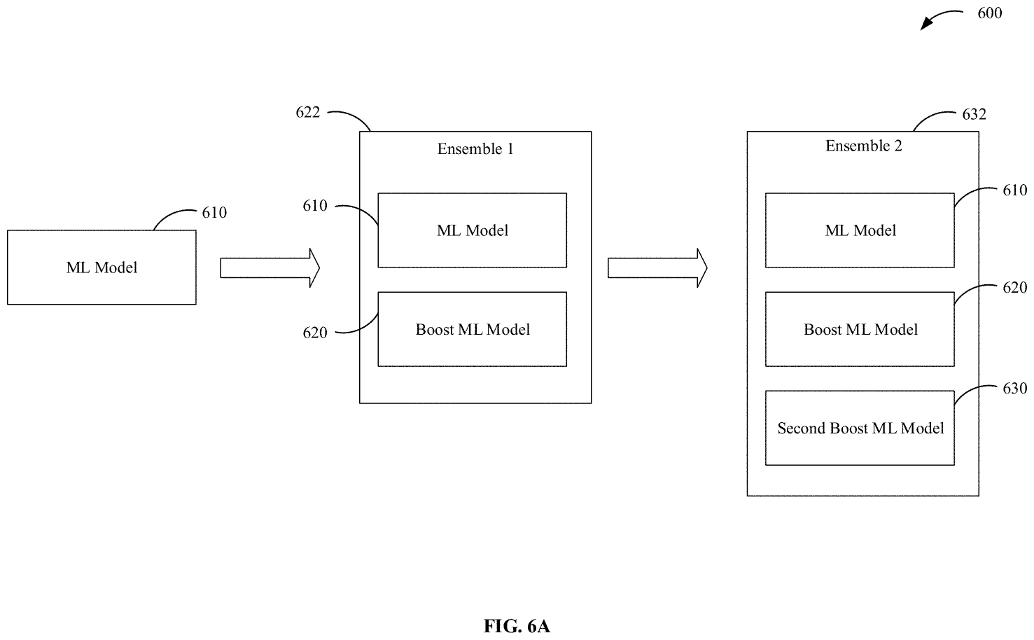

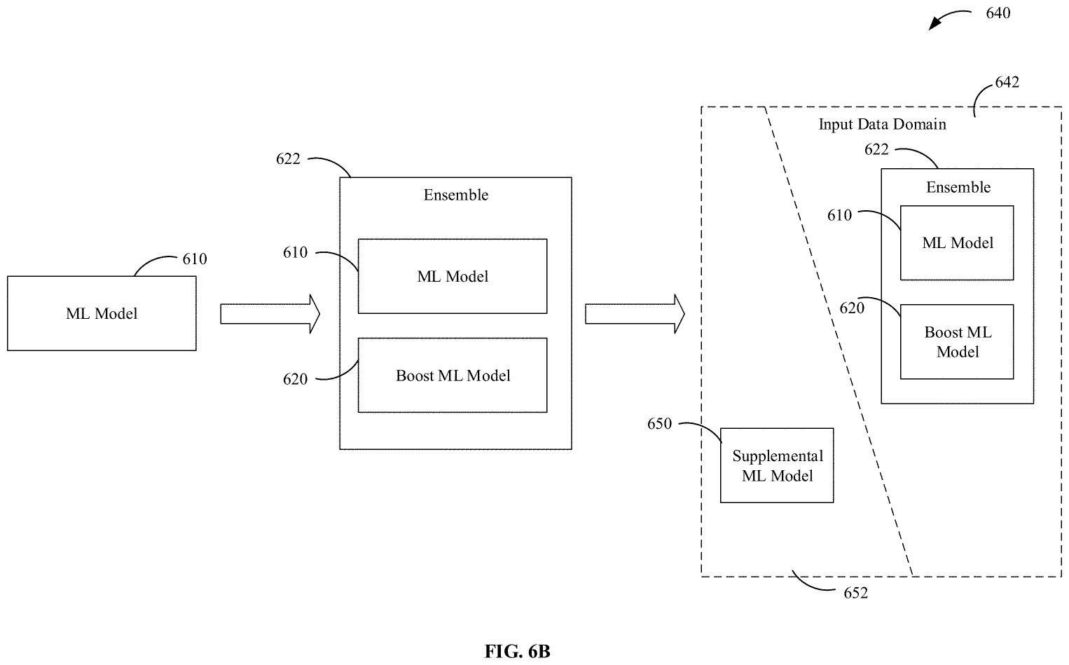

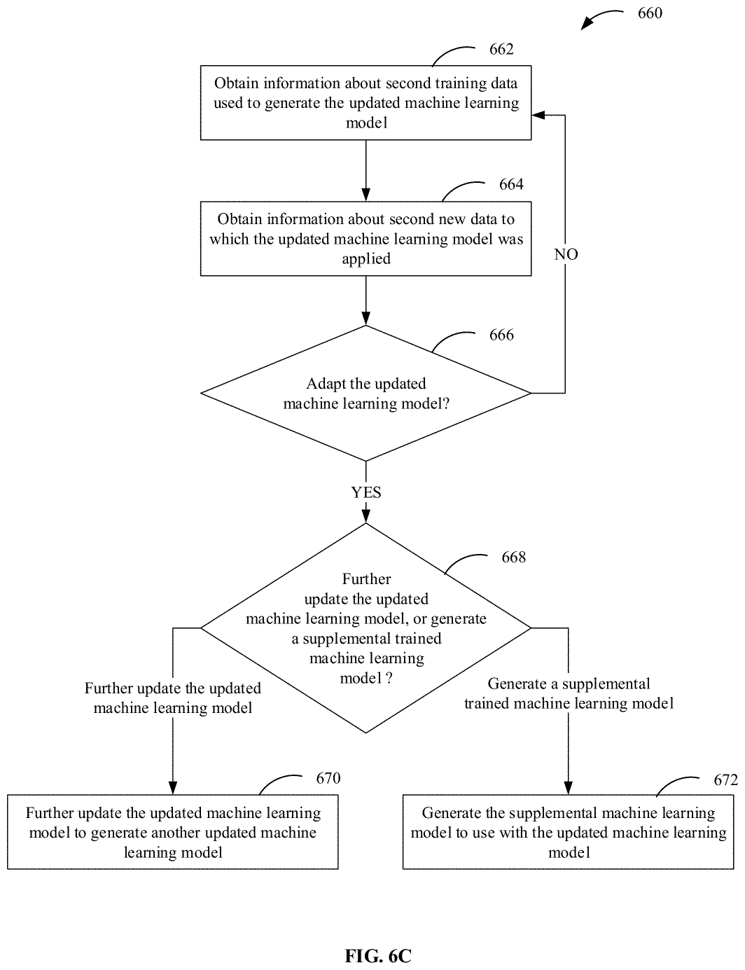

FIG. 6A shows block diagram 600 illustrating ML model 610, updated ML model 622 as a first ensemble of ML model 610 and boost ML model 620, and updated ML model 632 as a second ensemble of ML model 610, boost ML model 620, and second boost ML model 630. Boost ML model 620 or second boost ML model 630 may be generated using AdaBoost, XGBoost, Gradient Boosting Machine (GBM), or any other suitable boosting algorithm.

In some embodiments, when training boost ML model 620, input on which ML model 610 has low accuracy (e.g., the predicted outputs have average error higher than a threshold) is assigned a higher weight and input on which ML model 610 has high accuracy (e.g., the predicted outputs have average error lower than the threshold) is assigned a lower weight. Thus, boost ML model 620 may focus more on input on which ML model 610 performed poorly.

In some embodiments, when boost ML model 620 is added to the ensemble for updated ML model 622, ML model 610 and boost ML model 620 may be weighted (e.g., using a gradient descent algorithm, or any other suitable algorithm) in a way that improves overall accuracy for the ensemble. For example, weights w_{A} and w_{B} may be determined for ML model 610 and boost ML model 620, respectively.

Based on monitoring performance of updated ML model 622, it may be determined to further update updated ML model 622. In some embodiments, when training second boost ML model 630, input on which updated ML model 622 has low accuracy (e.g., the predicted outputs have average error higher than a threshold) is assigned a higher weight and input on which updated ML model 622 has high accuracy (e.g., the predicted outputs have average error lower than the threshold) is assigned a lower weight. Thus, second boost ML model 630 may focus more on input on which updated ML model 622 performed poorly.

In some embodiments, when second boost ML model 630 is added to the ensemble, weights w_{A}, w_{B}, and w_{C} may be determined for ML model 610, boost ML model 620, and second boost ML model 630, respectively.

FIG. 6B shows block diagram 640 illustrating ML model 610, updated ML model 622 as an ensemble of ML model 610 and boost ML model 620, and supplemental ML model 650 to use with updated ML model 622. Boost ML model 620 may be generated using AdaBoost, XGBoost, Gradient Boosting Machine (GBM), or any other suitable boosting algorithm.

In some embodiments, when training boost ML model 620, input on which ML model 610 has low accuracy (e.g., the predicted outputs have average error higher than a threshold) is assigned a higher weight and input on which ML model 610 has high accuracy (e.g., the predicted outputs have average error lower than the threshold) is assigned a lower weight. Thus, boost ML model 620 may focus more on input on which ML model 610 performed poorly.

In some embodiments, when boost ML model 620 is added to the ensemble for updated ML model 622, ML model 610 and boost ML model 620 may be weighted (e.g., using a gradient descent algorithm, or any other suitable algorithm) in a way that improves overall accuracy for the ensemble. For example, weights w_{A} and w_{B} may be determined for ML model 610 and boost ML model 620, respectively.

Based on monitoring performance of updated ML model 622, it may be determined to generate supplemental ML model 650 to use with updated ML model 622. Initially, updated ML model 622 may be applied to inputs from the entirety of the input data domain. In some embodiments, supplemental ML model 650 may be trained on some or all of training data used to train updated ML model 622 and/or some or all of new data on which updated ML model 622 has not yet been trained. For example, supplemental ML model 650 may be trained on training data and/or new data from a portion of the input data domain where updated ML model 622 has poor performance (e.g., model performance not below a threshold error level, or any other suitable indicator of poor model performance).

After supplemental ML model 650 is trained, the input data domain may be partitioned into portion 642, for which updated ML model 622 when applied to input data does not have poor performance (e.g., average error below a threshold, or any other suitable indicator of performance), and portion 652, for which updated ML model 622 when applied to input data has poor performance (e.g., average error not below the threshold, or any other suitable indicator of performance). Supplemental ML model 650 may be assigned to portion 652 of the input data domain. Supplemental ML model 650 may be used to generate ML output for input data that falls in portion 652 of the input data domain. Supplemental ML model 650 may show better performance than updated ML model 622 on this part of the input data domain. Updated ML model 622 may be assigned to portion 642 of the input data domain. Updated ML model 622 may be used to generate ML output for input data that falls in portion 642 of the input data domain.

FIG. 6C is a flowchart of process 660 for adapting an ML model (e.g., ML model 610 in FIG. 6A, ML model 610 in FIG. 6B, or any other suitable ML model). At least some of the acts of process 660 may be performed by any suitable computing device(s) and, for example, may be performed by one or more of processor(s) 802 shown in computing system 800 of FIG. 8.

In act 662, process 660 obtains information about second training data used to generate an updated ML model (e.g., updated ML model 622, or any other suitable ML model). In some embodiments, the second training data may include third inputs and corresponding third outputs. The information about the second training data may include a third representation (e.g., a third histogram, a third kernel density estimate, or any other suitable representation) of a third distribution of the third inputs and third performance data indicative of a measure of performance (e.g., a measure of average error, a measure of mean squared error, or any other suitable measure of performance) of the updated ML model on the third inputs.

After act 662, process 660 proceeds to act 664, where process 660 obtains information about second new data to which the updated ML model was applied. The second new data may include fourth inputs and corresponding fourth outputs. The information about the second new data may include a fourth representation (e.g., a fourth histogram, a first kernel density estimate, or any other suitable representation) of a fourth distribution of the fourth inputs and fourth performance data indicative of the measure of performance of the updated ML model on the fourth inputs.

After act 664, process 660 proceeds to act 666, where process 660 determines whether to adapt the updated ML model. In some embodiments, process 660 may determine whether to adapt the updated ML model based on the model performance being below or not below a specified error threshold. In some embodiments, process 660 may determine whether to adapt the updated ML model based on a periodic interval (e.g., every week, every month, every two months, or any other suitable interval). In some embodiments, process 660 may determine whether to adapt the updated ML model based on when a threshold amount (e.g., 20% of the size of the second training data initially used to generate the updated ML model, 50% of the size of the second training data initially used to generate the updated ML model, or any other suitable threshold) of second new data is available.

After act 666, when it is determined to not adapt the updated ML model, process 660 proceeds to act 662. For example, process 660 may determine to not adapt the updated ML model because the model performance is below a specified error threshold. In another example, process 660 may determine to not adapt the updated ML model because the current time does not comply with a periodic interval for adapting the updated ML model. In yet another example, process 660 may determine to not adapt the updated ML model because second new data may be received but may be less than a threshold amount of second new data required to trigger adapting the updated ML model.

After act 666, when it is determined to adapt the updated ML model, process 660 proceeds to act 668. For example, process 660 may determine to adapt the updated ML model because the model performance is not below a specified error threshold. In another example, process 660 may determine to adapt the updated ML model because the current time complies with a periodic interval for adapting the updated ML model. In yet another example, process 660 may determine to adapt the updated ML model because the received second new data may be more than a threshold amount of second new data required to trigger adapting the updated ML model.

In act 668, where process 660 determines, using the third representation, the fourth representation, the third performance data, and the fourth performance data, whether to further update the updated ML model or to generate a supplemental ML model to use with the updated ML model. In some embodiments, a comparison between the third representation and the fourth representation may be performed. For example, the comparison may be performed by determining a KL divergence between the third representation and the fourth representation. In some embodiments, a comparison between the third performance data and the fourth performance data may be performed. For example, the comparison may be performed by determining a KL divergence between the third performance data and the fourth performance data. In some embodiments, a first value may be determined based on the comparison between the third representation and the fourth representation. For example, the first value may be based on the determined KL divergence for the two representations. In some embodiments, a second value may be determined based on the comparison between the third performance data and the fourth performance data. For example, the second value may be based on the determined KL divergence for the two performance data. In some embodiments, a third value may be determined based on a weighted combination of the first value and the second value. Based on the determined third value, it may be determined whether to further update the updated ML model or to generate a supplemental ML model to use with the updated ML model.

After act 668, when it is determined to further update the updated ML model, process 660 proceeds to act 670, where process 660 further updates the updated ML model to generate another updated ML model (e.g., updated ML model 632 in FIG. 6A, or any other suitable ML model). In some embodiments, the updated ML model may be further updated by generating a third trained ML model (e.g., a boost ML model, or any other suitable ML model) and generating a further updated ML model as an ensemble of the updated ML model and the third trained ML model. In some embodiments, the third trained ML model may be a boost ML model generated using AdaBoost, XGBoost, Gradient Boosting Machine (GBM), or any other suitable boosting algorithm. In some embodiments, a boosting algorithm includes training the third trained ML model on some or all of the second training data and/or some or all of the second new data and adding the third trained ML model to an ensemble including the updated ML model which was trained on the second training data. In some embodiments, when training the third trained ML model, input on which the updated ML model has low accuracy (e.g., the predicted outputs have average error higher than a threshold) is assigned a higher weight and input on which the updated ML model has high accuracy (e.g., the predicted outputs have average error lower than the threshold) is assigned a lower weight. Thus, the third trained ML model may focus more on input on which the updated ML model performed poorly.

In some embodiments, generating the further updated ML model further includes determining weights for the updated ML model and the third trained ML model in the ensemble. For example, when the third trained ML model is added to the ensemble, the updated ML model and the third trained ML model are weighted in a way that improves overall accuracy for the ensemble. In some embodiments, determining the weights is performed by using gradient descent, or any other suitable technique for determining weights.

After act 668, when it is determined to generate the supplemental ML model to use with the updated ML model, process 660 proceeds to act 672, where process 660 generates the supplemental ML model (e.g., supplemental ML model 650 in FIG. 6B, or any other suitable ML model) to use with the updated ML model. In some embodiments, the supplemental ML model may be trained on some or all of the second training data and/or some or all of the second new data. For example, the supplemental ML model may be trained on second training data and/or second new data from a portion of the input data domain where the updated ML model has poor performance. The input data domain may be partitioned into a first portion, for which the updated ML model when applied to input data does not have poor performance, and a second portion, for which the updated ML model when applied to input data has poor performance. The supplemental ML model may be assigned to the second portion of the input data domain. The supplemental ML model may be used to generate ML output for input data that falls in its assigned portion of the input data domain. The updated ML model may be assigned to the first portion of the input data domain. The updated ML model may be used to generate ML output for input data that falls in its assigned portion of the input data domain.

It should be appreciated that process 660 is illustrative and that there are variations. In some embodiments, one or more of the acts of process 660 may be optional or be performed in a different order than shown in FIG. 6C. For example, act 662 and act 664 may be performed in a different order. Alternatively, act 662 and act 664 may be performed in parallel.

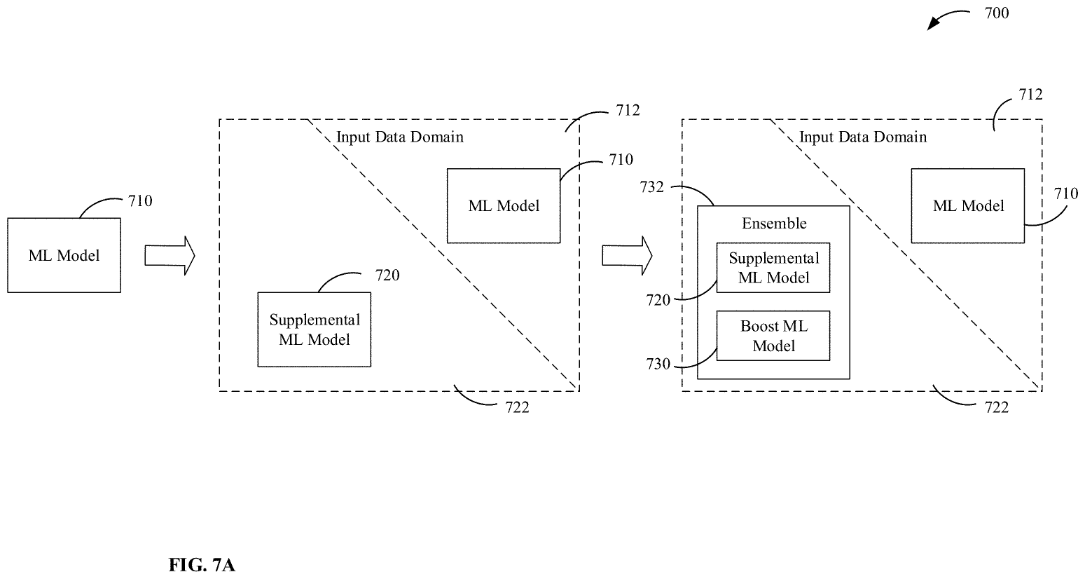

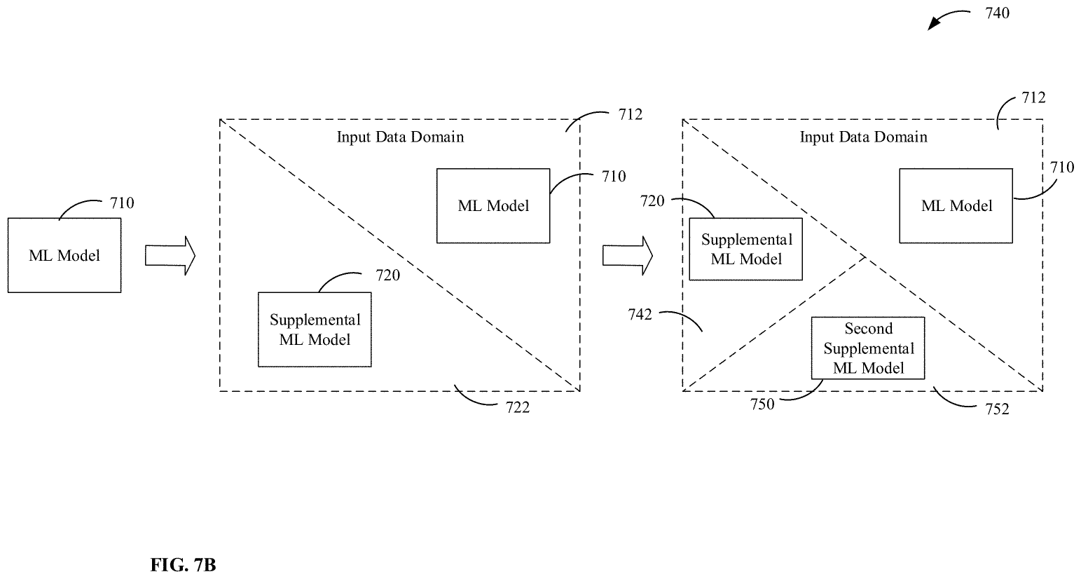

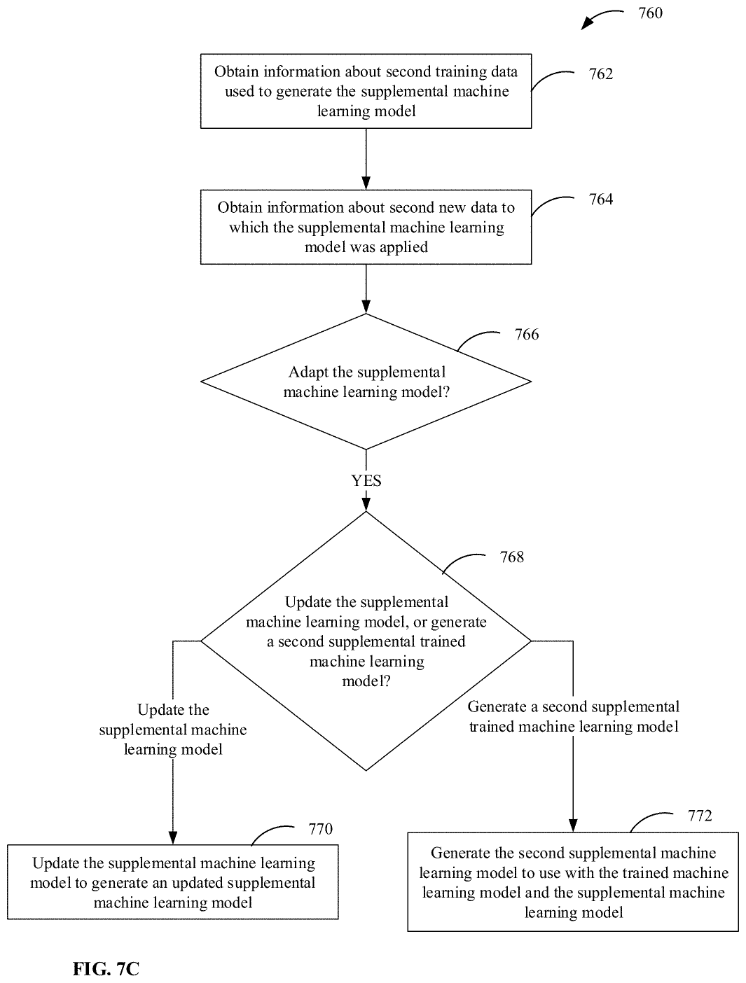

FIG. 7A shows block diagram 700 illustrating ML model 710, supplemental ML model 720 to use with ML model 710, and updated supplemental ML model 732 (as an ensemble of supplemental ML model 720 and boost ML model 730) to use with ML model 710. Initially, ML model 710 may be applied to inputs from the entirety of the input data domain. In some embodiments, supplemental ML model 720 may be trained on some or all of training data used to train ML model 710 and/or some or all of new data on which ML model 710 has not yet been trained. For example, supplemental ML model 720 may be trained on training data and/or new data from a portion of the input data domain where ML model 710 has poor performance (e.g., model performance not below a threshold error level, or any other suitable indicator of poor model performance).

After supplemental ML model 720 is trained, the input data domain may be partitioned into portion 722, for which ML model 710 when applied to input data does not have poor performance (e.g., average error below a threshold, or any other suitable indicator of performance), and portion 712, for which ML model 710 when applied to input data has poor performance (e.g., average error not below the threshold, or any other suitable indicator of performance). Supplemental ML model 720 may be assigned to portion 722 of the input data domain. Supplemental ML model 720 may be used to generate ML output for input data that falls in portion 722 of the input data domain. Supplemental ML model 720 may show better performance than ML model 710 on this part of the input data domain. ML model 710 may be assigned to portion 712 of the input data domain. ML model 710 may be used to generate ML output for input data that falls in portion 712 of the input data domain.

Based on monitoring performance of supplemental ML model 720, it may be determined to update supplemental ML model 720. Boost ML model 730 may be generated using AdaBoost, XGBoost, Gradient Boosting Machine (GBM), or any other suitable boosting algorithm.

In some embodiments, when training boost ML model 730, input on which supplemental ML model 720 has low accuracy (e.g., the predicted outputs have average error higher than a threshold) is assigned a higher weight and input on which supplemental ML model 720 has high accuracy (e.g., the predicted outputs have average error lower than the threshold) is assigned a lower weight. Thus, boost ML model 730 may focus more on input on which supplemental ML model 720 performed poorly.

In some embodiments, when boost ML model 730 is added to the ensemble for updated supplemental ML model 732, supplemental ML model 720 and boost ML model 730 may be weighted (e.g., using a gradient descent algorithm, or any other suitable algorithm) in a way that improves overall accuracy for the ensemble. For example, weights w_{A} and w_{B} may be determined for supplemental ML model 720 and boost ML model 730, respectively.

FIG. 7B shows block diagram 740 illustrating ML model 710, supplemental ML model 720 to use with ML model 710, and second supplemental ML model 750 to use with ML model 710 and supplemental ML model 720. Initially, ML model 710 may be applied to inputs from the entirety of the input data domain. In some embodiments, supplemental ML model 720 may be trained on some or all of training data used to train ML model 710 and/or some or all of new data on which ML model 710 has not yet been trained. For example, supplemental ML model 720 may be trained on training data and/or new data from a portion of the input data domain where ML model 710 has poor performance (e.g., model performance not below a threshold error level, or any other suitable indicator of poor model performance).

After supplemental ML model 720 is trained, the input data domain may be partitioned into portion 722, for which ML model 710 when applied to input data does not have poor performance (e.g., average error below a threshold, or any other suitable indicator of performance), and portion 712, for which ML model 710 when applied to input data has poor performance (e.g., average error not below the threshold, or any other suitable indicator of performance). Supplemental ML model 720 may be assigned to portion 722 of the input data domain. Supplemental ML model 720 may be used to generate ML output for input data that falls in portion 722 of the input data domain. Supplemental ML model 720 may show better performance than ML model 710 on this part of the input data domain. ML model 710 may be assigned to portion 712 of the input data domain. ML model 710 may be used to generate ML output for input data that falls in portion 712 of the input data domain.

Based on monitoring performance of supplemental ML model 720, it may be determined to generate second supplemental ML model 750 to use with ML model 710 and supplemental ML model 720. Previously, supplemental ML model 720 may be applied to all inputs from portion 722 of the input data domain. In some embodiments, second supplemental ML model 750 may be trained on some or all of training data used to train supplemental ML model 720 and/or some or all of new data on which supplemental ML model 720 has not yet been trained. For example, second supplemental ML model 750 may be trained on training data and/or new data from a portion of the input data domain where supplemental ML model 720 has poor performance (e.g., model performance not below a threshold error level, or any other suitable indicator of poor model performance).

After second supplemental ML model 750 is trained, portion 722 of the input data domain may be partitioned into portion 742, for which supplemental ML model 720 when applied to input data does not have poor performance (e.g., average error below a threshold, or any other suitable indicator of performance), and portion 752, for which supplemental ML model 720 when applied to input data has poor performance (e.g., average error not below the threshold, or any other suitable indicator of performance). Second supplemental ML model 750 may be assigned to portion 752 of the input data domain. Second supplemental ML model 750 may be used to generate ML output for input data that falls in portion 752 of the input data domain. Second supplemental ML model 750 may show better performance than supplemental ML model 720 on this part of the input data domain. Supplemental ML model 720 may be assigned to portion 742 of the input data domain. Supplemental ML model 720 may be used to generate ML output for input data that falls in portion 742 of the input data domain.

FIG. 7C is a flowchart of process 760 for adapting an ML model (e.g., ML model 710 in FIG. 7A, ML model 710 in FIG. 7B, or any other suitable ML model). At least some of the acts of process 760 may be performed by any suitable computing device(s) and, for example, may be performed by one or more of processor(s) 802 shown in computing system 800 of FIG. 8.

In act 762, process 760 obtains information about second training data used to generate a supplemental ML model (e.g., supplemental ML model 720 in FIG. 7A, or any other suitable ML model). In some embodiments, the second training data may include third inputs and corresponding third outputs. The information about the second training data may include a third representation (e.g., a third histogram, a third kernel density estimate, or any other suitable representation) of a third distribution of the third inputs and third performance data indicative of a measure of performance (e.g., a measure of average error, a measure of mean squared error, or any other suitable measure of performance) of the supplemental ML model on the third inputs.

After act 762, process 760 proceeds to act 764, where process 760 obtains information about second new data to which the supplemental ML model was applied. The second new data may include fourth inputs and corresponding fourth outputs. The information about the second new data may include a fourth representation (e.g., a fourth histogram, a first kernel density estimate, or any other suitable representation) of a fourth distribution of the fourth inputs and fourth performance data indicative of the measure of performance of the supplemental ML model on the fourth inputs.

After act 764, process 760 proceeds to act 766, where process 760 determines whether to adapt the supplemental ML model. In some embodiments, process 760 may determine whether to adapt the supplemental ML model based on the model performance being below or not below a specified error threshold. In some embodiments, process 760 may determine whether to adapt the supplemental ML model based on a periodic interval (e.g., every week, every month, every two months, or any other suitable interval). In some embodiments, process 760 may determine whether to adapt the supplemental ML model based on when a threshold amount (e.g., 20% of the size of the second training data initially used to generate the supplemental ML model, 50% of the size of the second training data initially used to generate the supplemental ML model, or any other suitable threshold) of second new data is available.

After act 766, when it is determined to not adapt the supplemental ML model, process 760 proceeds to act 762. For example, process 760 may determine to not adapt the supplemental ML model because the model performance is below a specified error threshold. In another example, process 760 may determine to not adapt the supplemental ML model because the current time does not comply with a periodic interval for adapting the supplemental ML model. In yet another example, process 760 may determine to not adapt the supplemental ML model because second new data may be received but may be less than a threshold amount of second new data required to trigger adapting the supplemental ML model.

After act 766, when it is determined to adapt the supplemental ML model, process 760 proceeds to act 768. For example, process 760 may determine to adapt the supplemental ML model because the model performance is not below a specified error threshold. In another example, process 760 may determine to adapt the supplemental ML model because the current time complies with a periodic interval for adapting the supplemental ML model. In yet another example, process 760 may determine to adapt the supplemental ML model because the received second new data may be more than a threshold amount of second new data required to trigger adapting the supplemental ML model.

In act 768, process 760 determines, using the third representation, the fourth representation, the third performance data, and the fourth performance data, whether to update the supplemental ML model or to generate a second supplemental ML model to use with the trained ML model and the supplemental ML model. In some embodiments, a comparison between the third representation and the fourth representation may be performed. For example, the comparison may be performed by determining a KL divergence between the third representation and the fourth representation. In some embodiments, a comparison between the third performance data and the fourth performance data may be performed. For example, the comparison may be performed by determining a KL divergence between the third performance data and the fourth performance data. In some embodiments, a first value may be determined based on the comparison between the third representation and the fourth representation. For example, the first value may be based on the determined KL divergence for the two representations. In some embodiments, a second value may be determined based on the comparison between the third performance data and the fourth performance data. For example, the second value may be based on the determined KL divergence for the two performance data. In some embodiments, a third value may be determined based on a weighted combination of the first value and the second value. Based on the determined third value, it may be determined whether to update the supplemental ML model or to generate a second supplemental ML model to use with the trained ML model and the supplemental ML model.

After act 768, when it is determined to update the supplemental ML model, process 760 proceeds to act 770, where process 760 updates the supplemental ML model to generate an updated supplemental ML model (e.g., updated supplemental ML model 732 in FIG. 7A, or any other suitable ML model). In some embodiments, the supplemental ML model may be updated by generating a third trained ML model (e.g., a boost ML model, or any other suitable ML model) and generating an updated supplemental ML model as an ensemble of the supplemental ML model and the third trained ML model. In some embodiments, the third trained ML model may be a boost ML model generated using AdaBoost, XGBoost, Gradient Boosting Machine (GBM), or any other suitable boosting algorithm. In some embodiments, a boosting algorithm includes training the third trained ML model on some or all of the second training data and/or some or all of the second new data and adding the third trained ML model to an ensemble including the supplemental ML model which was trained on the second training data. In some embodiments, when training the third trained ML model, input on which the supplemental ML model has low accuracy (e.g., the predicted outputs have average error higher than a threshold) is assigned a higher weight and input on which the supplemental ML model has high accuracy (e.g., the predicted outputs have average error lower than the threshold) is assigned a lower weight. Thus, the third trained ML model may focus more on input on which the supplemental ML model performed poorly.

In some embodiments, generating the updated supplemental ML model further includes determining weights for the supplemental ML model and the third trained ML model in the ensemble. For example, when the third trained ML model is added to the ensemble, the supplemental ML model and the third trained ML model are weighted in a way that improves overall accuracy for the ensemble. In some embodiments, determining the weights is performed by using gradient descent, or any other suitable technique for determining weights.

After act 768, when it is determined to generate the second supplemental ML model to use with the trained ML model and the supplemental ML model, process 760 proceeds to act 772, where process 760 generates the second supplemental ML model (e.g., second supplemental ML model 750 in FIG. 7B, or any other suitable ML model) to use with the trained ML model (e.g., model 710 in FIG. 7B, or any other suitable ML model) and the supplemental ML model (e.g., supplemental ML model 720 in FIG. 7B, or any other suitable ML model).

In some embodiments, the second supplemental ML model may be trained on some or all of the second training data and/or some or all of the second new data. For example, the second supplemental ML model may be trained on second training data and/or second new data from a portion of the input data domain where the supplemental ML model has poor performance. The input data domain may be partitioned into a first portion, for which the supplemental ML model when applied to input data does not have poor performance, and a second portion, for which the supplemental ML model when applied to input data has poor performance. The second supplemental ML model may be assigned to the second portion of the input data domain. The second supplemental ML model may be used to generate ML output for input data that falls in its assigned portion of the input data domain. The supplemental ML model may be assigned to the first portion of the input data domain. The supplemental ML model may be used to generate ML output for input data that falls in its assigned portion of the input data domain.

It should be appreciated that process 760 is illustrative and that there are variations. In some embodiments, one or more of the acts of process 760 may be optional or be performed in a different order than shown in FIG. 7C. For example, act 762 and act 764 may be performed in a different order. Alternatively, act 762 and act 764 may be performed in parallel.

An illustrative implementation of a computing system 800 that may be used in connection with any of the embodiments of the disclosure provided herein is shown in FIG. 8. For example, any of the computing devices described above may be implemented as computing system 800. The computing system 800 may include one or more computer hardware processors 802 and one or more articles of manufacture that comprise non-transitory computer-readable storage media (e.g., memory 804 and one or more non-volatile storage devices 806). The processor(s) 802 may control writing data to and reading data from the memory 804 and the non-volatile storage device(s) 806 in any suitable manner. To perform any of the functionality described herein, the processor(s) 802 may execute one or more processor-executable instructions stored in one or more non-transitory computer-readable storage media (e.g., the memory 804), which may serve as non-transitory computer-readable storage media storing processor-executable instructions for execution by the processor(s) 802.

The terms “program” or “software” are used herein in a generic sense to refer to any type of computer code or set of processor-executable instructions that may be employed to program a computer or other processor to implement various aspects of embodiments as described above. Additionally, according to one aspect, one or more computer programs that when executed perform methods of the disclosure provided herein need not reside on a single computer or processor but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements);etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing,” “involving,” and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method, comprising:
using at least one computer hardware processor to perform:
(A) obtaining information about training data used to generate a trained machine learning (ML) model, the training data comprising a first plurality of inputs and a corresponding first plurality of outputs, the information about the training data comprising:
a first representation of a first distribution of the first plurality of inputs, and
first performance data indicative of a measure of performance of the trained ML model on the first plurality of inputs;
(B) obtaining information about new data to which the trained ML model was applied, the new data comprising a second plurality of inputs and a corresponding second plurality of outputs, the information about the new data comprising:
a second representation of a second distribution of the second plurality of inputs, and
second performance data indicative of the measure of performance of the trained ML model on the second plurality of inputs;
(C) determining, using the first representation, the second representation, the first performance data, and the second performance data, whether to update the trained ML model or to generate a supplemental ML model to use with the trained ML model; and
(D) when it is determined to update the trained ML model or to generate the supplemental ML model to use with the trained ML model, updating the trained ML model to generate an updated ML model or generating the supplemental ML model to use with the trained ML model.

2. The method of claim 1, wherein (C) comprises determining to update the trained ML model and (D) comprises updating the trained ML model to generate the updated ML model.

3. The method of claim 2, wherein updating the trained ML model comprises:
training, using at least some of the new data, a second trained ML model;
generating the updated ML model as an ensemble of the trained ML model and the second trained ML model.

4. The method of claim 3, wherein generating the updated ML model further comprises determining weights for the trained ML model and the second trained ML model in the ensemble.

5. The method of claim 2, wherein the method further comprises:
obtaining information about second training data used to generate the updated machine learning model, the second training data comprising a third plurality of inputs and a corresponding third plurality of outputs, the information about the second training data comprising:
a third representation of a third distribution of the third plurality of inputs, and
third performance data indicative of a measure of performance of the updated ML model on the third plurality of inputs;
obtaining information about second new data to which the updated ML model was applied, the second new data comprising a fourth plurality of inputs and a corresponding fourth plurality of outputs, the information about the second new data comprising:
a fourth representation of a fourth distribution of the fourth plurality of inputs, and
fourth performance data indicative of the measure of performance of the updated ML model on the fourth plurality of inputs;
determining, using the third representation, the fourth representation, the third performance data, and the fourth performance data, whether to further update the updated ML model or to generate a further supplemental ML model to use with the updated ML model; and
when it is determined to further update the updated ML model or to generate the further supplemental ML model to use with the updated ML model, updating the updated ML model or generating the further supplemental ML model.

6. The method of claim 1, wherein (C) comprises determining to generate the supplemental ML model to use with the trained ML model and (D) comprises generating the supplemental ML model.

7. The method of claim 6, wherein generating the supplemental ML model comprises:
training, using at least some of the new data, the supplemental ML model;
associating the trained ML model with a first portion of an input data domain; and
associating the supplemental ML model with a second portion of the input data domain.

8. The method of claim 7, wherein the method further comprises:
obtaining new input data;
determining whether the new input data is in the first portion of the input data domain or in the second portion of the input data domain;
when it is determined that the new input data is in the first portion of the input data domain, providing the new input data as input to the trained ML model to obtain a first corresponding output; and
when it is determined that the new input data is in the second portion of the input data domain, providing the new input data as input to the supplemental ML model to obtain a second corresponding output.

9. The method of claim 8, further comprising:
monitoring performance of the trained ML model and the supplemental ML model; and
adjusting portions of the input data domain associated with the trained ML model and the supplemental ML model based on results of the monitoring,
wherein adjusting the portions comprises adjusting a boundary between the first portion of the input data domain and the second portion of the input data domain thereby changing the first portion and the second portion of the input data domain.

10. The method of claim 6, wherein the method further comprises:
obtaining information about second training data used to generate the supplemental ML model, the second training data comprising a third plurality of inputs and a corresponding third plurality of outputs, the information about the second training data comprising:
a third representation of a third distribution of the third plurality of inputs, and
third performance data indicative of a measure of performance of the supplemental ML model on the third plurality of inputs;
obtaining information about second new data to which the supplemental ML model was applied, the second new data comprising a fourth plurality of inputs and a corresponding fourth plurality of outputs, the information about the second new data comprising:
a fourth representation of a fourth distribution of the fourth plurality of inputs, and
fourth performance data indicative of the measure of performance of the supplemental ML model on the fourth plurality of inputs;
determining, using the third representation, the fourth representation, the third performance data, and the fourth performance data, whether to further update the supplemental ML model or to generate a second supplemental ML model to use with the trained ML model and the supplemental ML model; and
when it is determined to further update the supplemental ML model or to generate the second supplemental ML model to use with the trained ML model and the supplemental ML model, updating the supplemental ML model or generating the second supplemental ML model.

11. The method of claim 1, wherein the first representation of the first distribution of the first plurality of inputs comprises a histogram having a plurality of bins and a plurality of counts corresponding to the plurality of bins, each of the plurality of counts indicating how many of the first plurality of inputs fall into a respective bin in the plurality of bins.

12. The method of claim 11, wherein the first performance data indicative of the measure of performance of the trained ML model on the first plurality of inputs comprises:
for each bin of at least some of the plurality of bins, a measure of average error by the trained ML model when applied to inputs, among the first plurality of inputs, that fall in the bin.

13. The method of claim 1, further comprising:
prior to obtaining the information about the new data, applying the trained ML model to the second plurality of inputs to obtain the second plurality of outputs.

14. The method of claim 1, further comprising:
prior to obtaining the information about the training data, training, using the first plurality of inputs and the first plurality of outputs, an untrained ML model to generated the trained ML model.

15. The method of claim 1, wherein the determining comprises:
determining a first value based on a comparison between the first representation and the second representation;
determining a second value based on a comparison between the first performance data and the second performance data; and
determining, based on a weighted combination of the first value and the second value, whether to update the trained ML model or to generate a supplemental ML model to use with the trained ML model.

16. The method of claim 1,
wherein the first representation comprises a first histogram having a first plurality of counts for a plurality of bins, and the second representation comprises a second histogram having a second plurality of counts for the plurality of bins,
wherein the first performance data comprises, for each bin of at least some of the plurality of bins, a measure of error incurred by the trained ML model when applied to inputs, among the first plurality of inputs, that fall in the bin, and
wherein the second performance data comprises, for each bin of at least some of the plurality of bins, a measure of error incurred by the trained ML model when applied to inputs, among the second plurality of inputs, that fall in the bin.

17. The method of claim 16, wherein determining whether to update the trained ML model or to generate a supplemental ML model comprises:
determining a number of bins, among the plurality of bins, for which a difference between measures of error specified by the first performance data and the second performance data exceeds an average difference between the measures of error across the plurality of bins;
determining to update the trained ML model when the number of bins exceeds a pre-determined threshold number of bins; and
determining to generate a supplemental ML model when the number of bins is less or equal to the pre-determined threshold number of bins.

18. The method of claim 1,
wherein the first representation of the first distribution of the first plurality of inputs comprises a first histogram having a plurality of bins,
wherein the second representation of the second distribution of the second plurality of inputs comprises a second histogram having the plurality of bins,
wherein the method further comprises:
identifying, using the first representation, the second representation, the first performance data and the second performance data, one or more bins for which to obtain additional inputs and corresponding ground truth values for improving performance of the trained ML model.

19. A system, comprising:
at least one computer hardware processor; and
at least one non-transitory computer-readable storage medium storing processor-executable instructions that, when executed by the at least one computer hardware processor, cause the at least one computer hardware processor to perform:
(A) obtaining information about training data used to generate a trained machine learning (ML) model, the training data comprising a first plurality of inputs and a corresponding first plurality of outputs, the information about the training data comprising:
a first representation of a first distribution of the first plurality of inputs, and
first performance data indicative of a measure of performance of the trained ML model on the first plurality of inputs;
(B) obtaining information about new data to which the trained ML model was applied, the new data comprising a second plurality of inputs and a corresponding second plurality of outputs, the information about the new data comprising:
a second representation of a second distribution of the second plurality of inputs, and
second performance data indicative of the measure of performance of the trained ML model on the second plurality of inputs;
(C) determining, using the first representation, the second representation, the first performance data, and the second performance data, whether to update the trained ML model or to generate a supplemental ML model to use with the trained ML model; and
(D) when it is determined to update the trained ML model or to generate the supplemental ML model to use with the trained ML model, updating the trained ML model to generate an updated ML model or generating the supplemental ML model to use with the trained ML model.

20. At least one non-transitory computer-readable storage medium storing processor-executable instructions that, when executed by at least one computer hardware processor, cause the at least one computer hardware processor to perform:
(A) obtaining information about training data used to generate a trained machine learning (ML) model, the training data comprising a first plurality of inputs and a corresponding first plurality of outputs, the information about the training data comprising:
a first representation of a first distribution of the first plurality of inputs, and
first performance data indicative of a measure of performance of the trained ML model on the first plurality of inputs;
(B) obtaining information about new data to which the trained ML model was applied, the new data comprising a second plurality of inputs and a corresponding second plurality of outputs, the information about the new data comprising:
a second representation of a second distribution of the second plurality of inputs, and
second performance data indicative of the measure of performance of the trained ML model on the second plurality of inputs;
(C) determining, using the first representation, the second representation, the first performance data, and the second performance data, whether to update the trained ML model or to generate a supplemental ML model to use with the trained ML model; and
(D) when it is determined to update the trained ML model or to generate the supplemental ML model to use with the trained ML model, updating the trained ML model to generate an updated ML model or generating the supplemental ML model to use with the trained ML model.
